(19) United States
(12) Patent Application Publication
(10) Pub. No.: US 2025/0357835 A1
(43) Pub. Date: Nov. 20, 2025

(54) ELECTRIC GENERATOR DEVICE

(71) Applicant: Preciflex SA, Neuchâtel (CH)

(72) Inventors: Fabien GIGON, Colombier (CH); Carlos DA SILVA, Fleurier (CH); Fabien LUGINBÜHL, La Chaux-de-Fonds (CH); Toralf BORK, Enges (CH); Luc MAFFLI, Corminboeuf (CH); Johann ROHNER, Pomy (CH); Grégory DOURDE, Neuchâtel (CH); Alain JACCARD, Sainte-Croix (CH)

(73) Assignee: Preciflex SA, Neuchâtel (CH)

(21) Appl. No.: 19/171,202

(22) Filed: Apr. 5, 2025

Related U.S. Application Data
(63) Continuation-in-part of application No. PCT/IB2024/053354, filed on Apr. 5, 2024.

(51) Int. Cl. H02K 21/14; H02K 7/08

(52) U.S. Cl. CPC H02K 21/145; H02K 7/085

(57) ABSTRACT

Disclosed is an electric generator device (20) including at least one rotor (22), at least one coil (26), and a magnetic or ferromagnetic bridge (24a, 24b). The rotor has an axis of rotation (22c) with magnetic elements (22b) disposed around said axis of rotation. The magnetic elements define pole pairs to create an alternating magnetic field when rotated around the axis of rotation. The coil is away from a direct influence of the alternating magnetic field. The bridge includes a first and second bridge elements joining the rotor to the coil. The bridge elements include teeth (24c) around the magnetic elements so that a voltage within the coil is induced due to the alternating magnetic field within the bridge caused by the rotation of the magnetic elements. The teeth are interdigitated between both bridge halves and their total number correspond to double the number of pole pairs of the magnetic elements.

### CROSS REFERENCE TO RELATED APPLICATIONS

This application claims priority to and is a continuation-in-part of PCT international application no. PCT/IB2024/053354, filed Apr. 5, 2024, which claims priority based on US 63/526,475filed Jul. 13, 2023, the content of the entirety of which is explicitly incorporated herein by reference and relied upon to define features for which protection may be sought hereby as it is believed that the entirety thereof contributes to solving the technical problem underlying the invention, some features that may be mentioned hereunder being of particular importance.

### IDENTIFICATION OF PARTIES CONCERNED

The Applicant of the present intellectual property matter is Preciflex Sa of Switzerland. The inventor(s) of the invention described in this patent documentation is/are Fabien Gigon, Carlos Da Silva, Fabien Luginbühl, Toralf Bork, Luc Maffli, Johann Rohner, Gregory Dourde, and Alain Jaccard, of Switzerland. At the time of filing, John B. Moetteli and the firm Da Vinci Partners LLC of Switzerland represent the Applicant.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### Field

This invention relates to electric generator devices, which is suitable for miniature applications.

### BACKGROUND OF THE INVENTION

Already known are generators in which a rotor, containing magnetic elements, is placed concentrically to the coil. Generators in which the rotor and the coil are arranged coaxially, are also known.

The disadvantage of this known solution is that there is less design flexibility and oversize in at least one dimension. When arranged in a miniature application, dimension of the miniature application is usually predefined by the dimension of such a generator. In particular, the integration of the known solution into wearable devices is made difficult by such design constraints.

The document CH597636B5 discloses a generator comprising a rotor and a coil, which are arranged on parallel axes. The document EP0751445 discloses a generator wherein several coils are arranged around an axis and the magnets of the rotor alternatively pass at close proximity of each of the coils. The document U.S. Pat. No. 6,124,649 discloses a generator having a rotor having two opposite plates with 6magnets and 3 coils arranged in series between the two opposite plates of the rotor. However, such configurations do not properly address the oversize of the system since the magnets of the rotor remain superimposed to the coils of the stator.

What is needed is a generator in which at least one dimension can be reduced. There is also more flexibility needed in the relative arrangement of the rotor and the coil. Another need is to provide watches or wearable devices with more functionalities. Specifically, in case of a mechanical watch, movable accessories or animations are most often provided through pure mechanical means. What is needed is thus to provide wearable devices, such as watches, in particular mechanical watches comprising some accessories such as lights or animations not directly activated by the mechanical source.

### SUMMARY OF THE INVENTION

Therefore, it is an object of the invention to provide an electric generator device. The electric generator device includes at least one rotor, at least one coil, and a magnetic or ferromagnetic bridge. The rotor has an axis of rotation and includes one or more magnetic elements disposed around the axis of rotation. The magnetic elements define pole pairs adapted to create an alternating magnetic field when rotated around the axis of rotation. The coil has a central axis and is remote from the rotor to be away from a direct influence of the alternating magnetic field. Further, the magnetic or ferromagnetic bridge includes at least a first and second bridge elements joining the rotor to the coil. The first and second bridge elements include teeth or protrusions at a vicinity of the magnetic elements so that a voltage within the coil is induced due to the alternating magnetic field within said magnetic or ferromagnetic bridge caused by the rotation of the magnetic elements. The teeth or protrusions are interdigitated between both halves of the magnetic or ferromagnetic bridge and a total number of the teeth or protrusions corresponds to double a number of pole pairs defined by the magnetic elements.

It is also an object of the invention or a task to be solved that the electric generator device saves space in at least one dimension. It is in particular an object of the present invention to provide a device having essentially the same width, but a reduced height compared with the known solutions.

It is also an object of the invention or a task to be solved that the electric generator device be more versatile, allowing a designer to implement the device, or parts of the device, either horizontally or vertically, or with other orientation.

It is also an object of the invention or a task to be solved that the electric generator device has at least similar output performance compared with the known solutions.

It is also an object of the invention or a task to be solved that the generator may be a stand-alone module.

It is also an object of the invention or a task to be solved that the generator ferromagnetic bridge might be an integral part of the mechanical arrangement such as a mechanical or electrical watch movement or a combination thereof.

It is also an object of the invention or a task to be solved that the generator is easily customized by adapting the outer shape and the mounting interface or the finishing aesthetics.

It is also an object of the invention or a task to be solved that the electric generator device has simple components.

It is also an object of the invention or a task to be solved that the electric generator allows for machined or additive 3D manufacturing or a combination thereof techniques, ferromagnetic bridge, an adaptive mounting interface and customizable aesthetic design. It is also an object of the invention to provide a wearable device such as a watch, a wristwatch, a jewel, a fashion item that encloses such electric generator or a task to be solved that the electric generator device saves space.

It is also an object of the invention to provide a wearable device such as a watch, a wristwatch, a jewel, a fashion item allowing for avoiding relying on a single source, like solar panel for example. It is a further object of the present invention to provide a wearable device such as a watch, a wristwatch, a jewel, a fashion item, in particular with a mechanical energy source as a principal energy source, and a secondary energy source for accessories such as electrically powered accessories.

The above-mentioned objects, or at least part of them, are realized by means of the subject-matter of the independent claims. The realization according to the present invention is further detailed in the claims depending thereof.

According to a preferred consideration, the present disclosure relates only to an electric generator regardless of whether such device could be used in motor or in generator mode.

The corresponding technical features and solutions are further described below.

In some additional, alternative, or selectively cumulative embodiments, the first bridge element forms a first plane orthogonal to the axis of rotation and the second bridge element forms a second plane orthogonal to the axis of rotation. The teeth of the first bridge element and the teeth of the second bridge element are arranged at an angle orthogonal to the corresponding first and second planes around the at least one rotor. The magnetic elements are arranged radially to the rotor to face the teeth of each of the first bridge element and the second bridge element. Such a configuration helps generate the alternating magnetic field. Further, a thickness or width or both of one or both of the first and second bridge elements decreases from the rotor to the coil (26), helping achieve an optimum magnetic field concentration towards the coil.

In some additional, alternative, or selectively cumulative embodiments, the rotor forms a rotation plane orthogonal to the axis of rotation and includes a rotor shaft. One end of the rotor shaft includes a coupling element adapted to transmit an external mechanical force to the rotor to rotate the rotor around the axis of rotation.

In some additional, alternative, or selectively cumulative embodiments, the central axis of the coil is non-parallel to the axis of rotation of the rotor so that the central axis is twisted with respect to the axis of rotation. This accounts for spatial constraints within the electric generator device.

In some additional, alternative, or selectively cumulative embodiments, the electric generator device includes at least two coils. Each coil includes one central axis and an overall centroidal axis passing through the overall geometrical center, or a barycenter, of all of the central axes. The overall centroidal axis is arranged non-concentrically and/or non-parallel with respect to the axis of rotation of the rotor. An electrical output or electrical power may be enhanced in this manner.

In some additional, alternative, or selectively cumulative embodiments, the magnetic or ferromagnetic bridge includes material selected from one of a group of materials including Fe, Co, Cr or Ni and a metalloid, preferably C, B, Si, V, M or an alloy of at least two of these materials for imbibing ferromagnetic properties.

In some additional, alternative, or selectively cumulative embodiments, the first bridge element includes a first bearing and the second bridge element includes a second bearing. The first and the second bridge elements are attached to each other by one or more screws engaged with a mating thread.

In some additional, alternative, or selectively cumulative embodiments, the first bridge element and the second bridge element each include interlocking elements for preventing a rotational displacement of the first bridge element relative to the second bridge element when the bridge elements are attached to each other by the screws engaged with the mating thread. An overall integrity and structure of the electric generator device can be preserved in this manner.

In some additional, alternative, or selectively cumulative embodiments, the magnetic or ferromagnetic bridge includes at least one extension for attaching the electric generator device to any mechanical structure.

In some additional, alternative, or selectively cumulative embodiments, the electric generator device including at least two coils. The two coils, or some of them, are connected in parallel, or the two coils, or some of them, are connected in series. An electrical output or electrical power may be regulated in this manner.

In some additional, alternative, or selectively cumulative embodiments, the number of teeth is equally distributed between both bridge halves and one tooth per half bridge is attributed to one pole of each of the pole pairs. This enables the electric generator device to operate in the intended manner.

In some additional, alternative, or selectively cumulative embodiments, all teeth per bridge halve are exposed to a same magnetic field direction. A magnetic field direction associated with one bridge halve is opposite to the magnetic field direction associated with the other bridge halve. This enables the electric generator device to operate in the intended manner of causing voltage inducement at the coil and thus providing an appropriate electrical output.

In some additional, alternative, or selectively cumulative embodiments, the magnetic elements are affixed to the rotor and are spaced apart from the teeth to define a radial distance or an air gap with the teeth. The radial distance is constant around the axis of rotation and is at least twice as small as an axial distance between the magnetic elements and the magnetic or ferromagnetic bridge. The air gap is defined anywhere within a range of 0.1 to 0.3 millimetres (mm) or within a range of 0.1 and 0.2 mm. This enables the electric generator device to operate in the intended manner of providing an appropriate electrical output.

In some additional, alternative, or selectively cumulative embodiments, each of the teeth, along the radial distance, has a width ranging anywhere between 0.1 to 0.4 mm or between 0.2 to 0.3 mm. This enables the electric generator device to operate in the intended manner of providing an appropriate electrical output.

In some additional, alternative, or selectively cumulative embodiments, the magnetic element includes at least one permanent magnet in a ring shape. The permanent magnet is radially magnetized into at least one pole pair. The permanent magnet includes at least one of a bonded permanent magnet or a sintered permanent magnet. The pole pairs associated with the magnetic element correspond to anywhere between 4 to 10 pole pairs or to 7 pole pairs. This enables the electric generator device to operate in the intended manner of providing an appropriate electrical output.

### BRIEF DESCRIPTION OF THE DRAWINGS

The attached drawings represent, by way of example, different embodiments of the invention.

FIG. 2A is a cross-sectional side view of a device of the prior art.

FIG. 2B is a cross-sectional top view of the device of the prior art shown in FIG. 2A.

FIG. 3A is a side view of an electric generator according to an embodiment the present invention (the arrows showing a reduced height).

FIG. 3B is a top view of the electric generator shown in FIG. 3A.

FIG. 3C is a perspective view of the electric generator shown in FIGS. 3A and 3B.

FIG. 4 is a perspective view of a coil of an electric generator according to an embodiment of the present invention.

FIG. 5 is a perspective view of a bridge element of an electric generator.

FIG. 6 is a cross-sectional view of another embodiment of an electric generator.

FIG. 7A is a top view of an electric generator according to an embodiment of the present invention.

FIG. 7B is a side view of the electric generator shown in FIG. 7A.

FIG. 7C is a top cross-section view of the electric generator shown in FIGS. 7A and 7B.

FIG. 8A is a top view of a further embodiment of an electric generator.

FIG. 8B is a side view of the electric generator shown in FIG. 8A.

FIG. 8C is a top view of a further embodiment of an electric generator according to the present invention.

FIG. 8D is a side view of an electric generator according to an embodiment of the present invention.

FIG. 9A is a side view of a further embodiment of an electric generator of the present invention.

FIG. 9B is a full side view of the embodiment of an electric generator of FIG. 9A which is modified to be symmetrical.

FIG. 9C is a top view of the electric generator shown in FIG. 9B.

FIG. 9D is a full side view of a further embodiment of an electric generator.

FIG. 9D is a side view of the electric generator according to another embodiment of the present invention.

FIG. 10A is a perspective view of a further embodiment of an electric generator according to the present invention.

FIG. 10B is a perspective view of a further embodiment of an electric generator.

FIG. 10C is a perspective view of the electric generator according to another embodiment of the present invention.

FIG. 10D is a perspective representation of some elements of the electric generator according to an embodiment of the present invention.

FIG. 10E is a perspective view of the electric generator according to another embodiment of the present invention.

FIG. 10F is a perspective view of the electric generator according to another embodiment of the present invention.

FIG. 10G is a perspective view of the electric generator according to another embodiment of the present invention.

FIG. 10H is a perspective view of the electric generator according to another embodiment of the present invention.

FIG. 10I is a perspective view of the electric generator according to another embodiment of the present invention.

FIG. 11A shows a connection schematics device.

FIG. 11B shows an alternative connection schematics of an electric generator.

FIG. 11C shows a further alternative connection schematic of an electric generator.

FIG. 12 is an exploded view of the electric generator device.

FIG. 13 is a side cross-sectional view of the electric generator device illustrating an exemplary working of the electric generator device.

FIG. 14 is an exemplary side view of the electric generator device with a section B-B marked.

FIG. 15 is the section B-B of the electric generator device of FIG. 14.

FIG. 16 is a relatively enlarged view of the rotor of the electric generator device of FIG. 14 and its interaction with teeth of the electric generator device.

FIG. 17 illustrates various exemplary iterations or embodiments of the magnetic elements.

FIG. 18 is an exemplary top view of the electric generator device with a section D-D marked.

FIG. 19 is a portion of the section D-D of the electric generator device of FIG. 18.

FIG. 20 is a perspective view of an exemplary assembly of the electric generator device.

FIG. 21 are exemplary views of an embodiment of the rotor of the electric generator device.

FIGS. 22A-22C show various isometric and cross-sectional views of the rotor according to another embodiment of the rotor of the electric generator device.

FIG. 23 is a sectional view of the electric generator device illustrating an exemplary accommodation of the rotor in between the teeth of the ferromagnetic elements of the electric generator device.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’, ‘top and bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

The prior art can be described according to the table below:

| Parameter | Motor | Generator |
|---|---|---|
| Definition | Convert electrical energy into | Convert mechanical energy into electrical |
| | mechanical energy. | energy. |
| Applicable | Maxwell-Faraday's law | Maxwell-Faraday's law |
| Law | Lenz-Faraday's law | Lenz-Faraday's law |
| | Lorentz force law | Lorentz force law |
| EMF | The electrical motor provides back | The generator provides EMF to the connected |
| | EMF to the circuit | load |
| Voltage | The motor provides rotor speed | The generator provides output voltage |
| | proportional to the input voltage | proportional to the rotor speed |
| Current | The motor provides output torque | The generator provides output current |
| | depending on mechanical load | depending on electrical load |
| Number of | Number of independent coils | Number of independent coils dedicated to |
| phases | dedicated to independent magnetic | independent magnetic bridges to get multiple |
| | bridges generating rotating magnetic | output voltage alternating signals at different |
| | field. different phase angles | phase angles |

| | |
|---|---|
| Amplitude | Absolute maximum value of an alternating signal |
| Period | Time to perform one cycle (positive and negative alternances) of an |
| | alternating signal |
| Frequency | Number of periods of an alternating signal per amount of time |
| Phase angle | Angle between 2 alternating signals cycles |

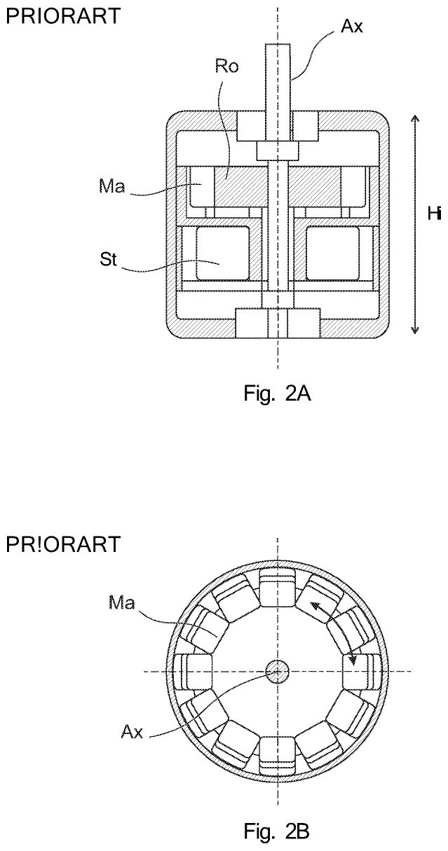

Referring now to FIG. 2A and 2B, a device of the prior art typically presents a stator St concentric with the rotor Ro, resulting in a significantly high form factor in the direction of the device's rotor's axis Ax. The height Hi partly results from the presence of the magnets Ma superimposed with the stator St. FIG. 2A shows the rotor Ro with its shaft Ax being arranged concentrically with its stator St. Coils are arranged in the vicinity of the rotor. Other arrangements of the prior art may provide non-concentric stator and rotor, still having a significant heigh Hi due to the magnet location.

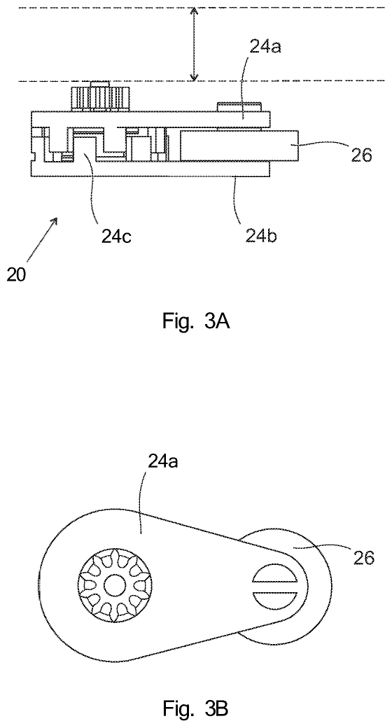

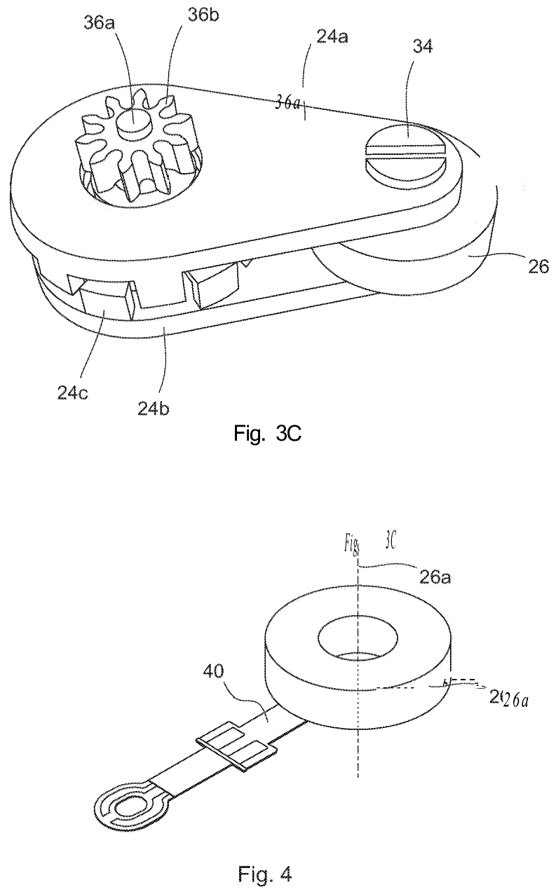

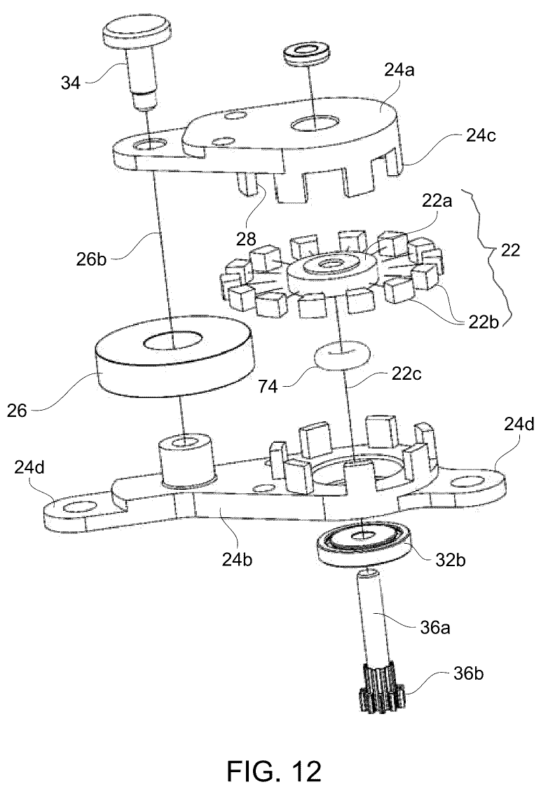

Referring now to FIG. 3A-3C, an electric generator 20 includes a rotor 22 (best visible on FIGS. 12, 21 and 22A-C) containing at least one magnetic element 22b. The rotor 22 has a rotor axis of rotation 22c in the vicinity of a magnetic or ferromagnetic bridge 24a, 24b for creating an alternating magnetic field within the magnetic bridge 24a, 24b during rotation of the rotor 22. The height reduction AH compared to prior art arrangement of FIGS. 2A and 2B is shown by the double arrow of FIG. 3A.

In this application, the terms magnetic or ferromagnetic mean any material that has a magnetic permeability equal to or greater than 1. A coil 26 or a likewise module is arranged in the vicinity of the magnetic bridge 24a, 24b for inducing a voltage within the coil 26 when the rotor 22 is rotating, due to the alternating magnetic field within the magnetic bridge 24a, 24b.

Referring now to FIG. 4, a coil 26 of an electric generator according to the present disclosure comprises an electrically conductive wire wound around a central axis 26a. The wire may present a circular cross-section, but may as well include any other appropriate shapes, like hexagonal, square, rectangular, rounded rectangle, oval, and/or the like shapes. The wire may be made of gold, of copper, of platinum, of aluminium, of graphene, or any alloy thereof, or any other appropriate metallic or non-metallic conductive material. The wire presents a peripheral electrical insulation, possibly made of one or more layers, to ensure no short-circuit between windings. When miniaturizing a coil, using a wire with a very small diameter is necessary if the number of turns (which directly impacts the induced voltage in the coil) must be kept constant. Because of the electrical insulation's thickness around the wire, the proportion of conductive wire decreases as the proportion of insulation in the coil's volume increases, resulting in a higher electrical resistance for a given induced voltage in a given coil volume, in other words a lower coil performance. There is therefore a performance limit to the miniaturization possibilities of a given coil and is a function of the industry's capability to produce small wires with a sufficient and still thin insulation. This loss of performance due to miniaturization can be compensated by using two or more coils with a larger wire cross-section in the electric generator, such coils being connected in series, in parallel, or in any series/parallel combination. Suitable electrical connection means are provided to connect the coils 26 to electrical elements, such as accessories of the devices.

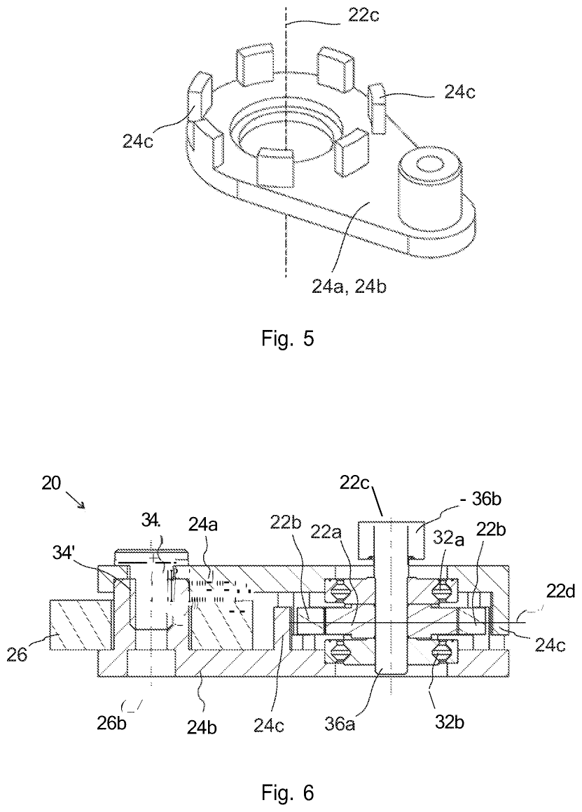

Referring now to FIG. 5, a magnetic or ferromagnetic bridge 24a, 24b or a first bridge element 24a of such a magnetic bridge 24a, 24b includes protrusions (or teeth) 24c in the vicinity of the rotor's magnetic elements 22b, located in a circle around the rotor's 22 axis of rotation 22c. The material of the magnetic bridge 24a, 24b and of the protrusions (or teeth) 24c may be magnetic stainless steel, ferromagnetic stainless steel or any other appropriate ferromagnetic or magnetic material or compound known in the industry that has a magnetic permeability equal or greater than 1. The material for the magnetic or ferromagnetic bridge 24a, 24b may be selected on the basis of additional criteria, such as aesthetic decoration possibilities and/or mechanical properties. The magnetic bridge 24a, 24b may advantageously be integral with a mechanical structure, the electric generator is attachable to, therefore a part of the mechanical structure forming the magnetic bridge 24a, 24b or a first bridge element 24a of the electric generator. The magnetic bridge 24a, 24b may contain at least two bridge elements 24a, 24b, machined, forged, 3D-printed, injected as appropriate for manufacturing possibilities and quantities to be produced.

The first and second bridge elements 24a, 24b are arranged so as to face each other at a distance adapted to lodge the rotor 22 in between. The first bridge element 24a may define an upper bridge element. At the vicinity of the axis of rotation 22c of the rotor, the first bridge element 24a forms a first plane, orthogonal to the axis of rotation 22c of the rotor 22. The teeth or protrusion 24c of the first bridge element 24a are oriented orthogonal to the first plane. In other words, the teeth of the first bridge element 24a are oriented parallel to the axis of rotation 22c of the rotor, so as to face the magnetic elements 22b. The second bridge element 24b may define a lower bridge element. At the vicinity of the axis of rotation 22c of the rotor 22, the second bridge element 24b forms a second plane, orthogonal to the axis of rotation 22c of the rotor 22, and parallel to the first plane. The teeth or protrusion 24c of the second bridge element 24b are oriented orthogonal to the second plane. In other words, the teeth of the second bridge element 24a are oriented parallel to the axis of rotation 22c of the rotor 22, so as to face the magnetic elements 22b. The teeth of the first bridge element 24a and the teeth of the second bridge element 24b are alternatively arranged around the rotor so that the magnetic elements 22b alternatively face each one of the teeth of the first bridge element 24a and the teeth of the second bridge element 24b.

As it will be better described below, the geometry of the teeth can be adapted.

According to an embodiment, the teeth of the first bridge element 24a can be oriented within the first plane or parallel the first plane, and the teeth of the second bridge element 24b are oriented within the second plane or parallel the second plane. The teeth can be integrated within the corresponding bridge element. The magnetic elements of the rotor are arranged so as to rotate between the teeth of the first bridge element 24a and the teeth of the second bridge element 24b.

According to another embodiment, the teeth of the first and second bridge elements 24a, 24b can be oriented with an angle different from 90° or 0° with respect to the corresponding bridge element 24a, 24b, such as an angle between 20° and 80°. This provides the opportunity to have longer teeth and thus a larger surface in front of the magnetic elements 22b. The magnetic elements 22b are oriented radially to the rotor 22 and are angled so as to properly face the inclined teeth.

The teeth here described are oriented between the first and the second bridge elements 24a, 24b so as to cross each other, except when they are arranged within the first plane and the second plane or parallel thereof.

The geometry of the magnetic or ferromagnetic bridge 24a, 24b is adapted to concentrate within itself and direct the magnetic field of the magnetic elements 22b to the coil 26 in order to improve the performance of the generator/motor. To this end, one or both of the bridge elements 24a, 24b can have a decreasing width from the rotor to the coils 26. Alternatively, or in addition, the thickness of one or both of the bridge elements 24a, 24b can decrease from the rotor 22 to the coils 26. Any other suitable tridimensional shape can be envisaged. Nevertheless, it may be that there are “leakages” of magnetic field due to the magnetic gap formed by the magnetic elements 22b within the magnetic generator/motor structure. In certain cases, such “leakage” could be disturbing to the environment of the generator/motor, and a magnetic shield may be added around certain areas or the whole generator/motor to protect its environment. Alternatively, or in addition, the thickness of one or both of the first and second bridge elements 24a, 24b can decrease from the rotor 22 to the coil 26.

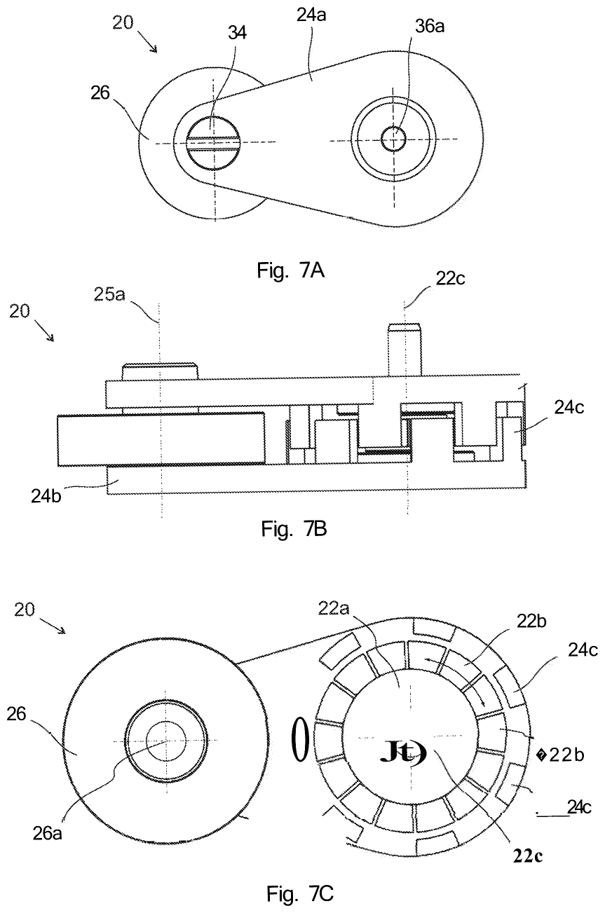

Referring now to FIGS. 6 and 7A-7C, an electric generator 20 comprises a rotor 22, a coil 26 and a magnetic or ferromagnetic bridge 24a, 24b. The rotor 22 includes at least one magnetic element 22b. The magnetic elements 22b are arranged so that their magnetic field extends radially relative to the axis of rotation 22c in alternating head-to-tail directions. The rotor 22 is able to rotate around an axis of rotation 22c as the rotor 22 is rotatably mounted at its axis of rotation 22c. The rotor 22 has a rotation plane 22d in the plane of rotation of the rotor 22, perpendicular to the rotational axis 22c of the rotor 22.

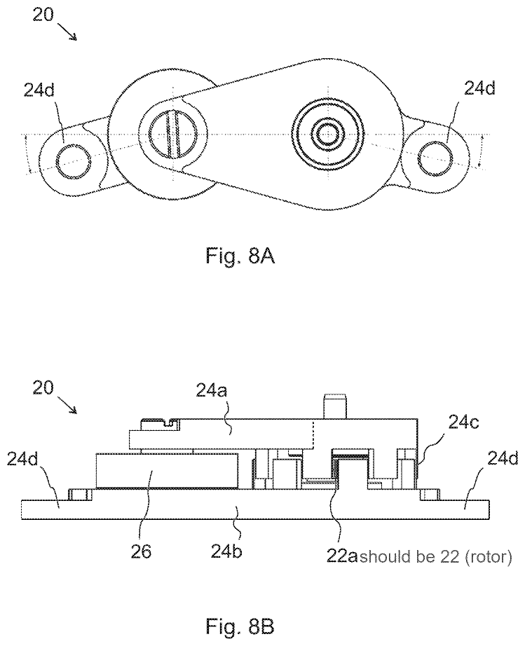

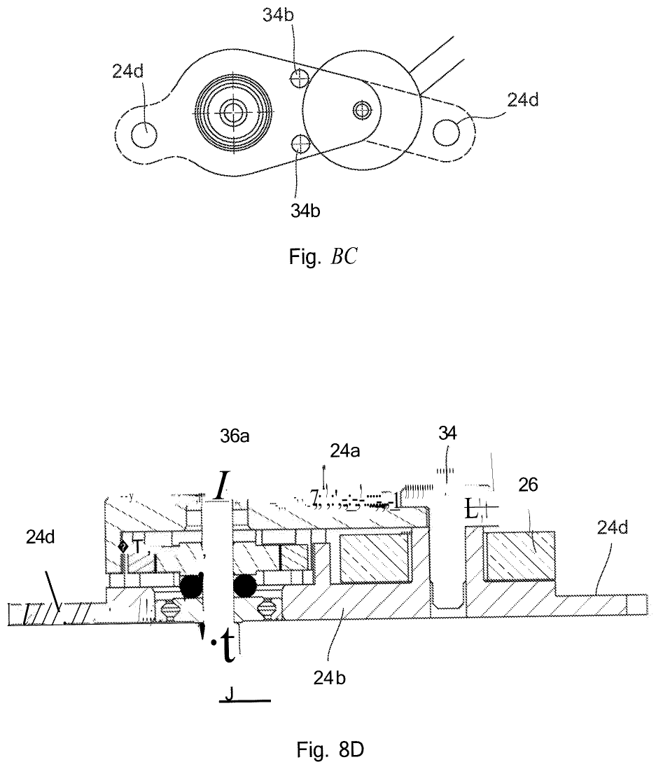

The magnetic or ferromagnetic bridge 24a, 24b may include a first bridge element 24a and a second bridge element 24b for an easier assembling of the electric generator 20. Therefore, the first bridge element 24a is fixable to the second bridge element 24b by one fixing element 34 only or several fixing elements 34. Such fixing elements can denote a screw (FIG. 7A). In such a case, the fixing element 34 is interacting with a thread 34′, which is a component of the first or second bridge element 24a, 24b. Alternatively, the fixing element 34 may be one or several pins which is press fitted in dedicated holes of the magnetic or ferromagnetic bridge 24a, 24b, as shown for example in FIG. 8C. In case the fixing is not across the coil center, the fixing elements need to be on magnetically not conducting material. Any other suitable fixing means can be envisaged. The first and/or the second bridge element 24a, 24b may include at least one interlocking element (not represented) for form-locking the first bridge element 24a to the second bridge element 24b for preventing rotational displacement of the two bridge elements 24a, 24b, when attached to each other with only one fixing element 34. Alternatively, several fixing elements can be arranged, either of the same type or of different types. If the fixing elements are placed at the centre of the coil, then they must be made of magnetic or ferromagnetic material so as to participate to the magnetic field concentration at the centre of the coil. If placed outside the centre of the coil then they must be made of non-magnetic material so as to not short-circuit the magnetic field.

The protrusions (or teeth) 24c provide a magnetic coupling with the magnetic element 22b, so that an alternating magnetic field is generated within the magnetic or ferromagnetic bridge 24a, 24b when the magnetic element 22b moves in the vicinity of the protrusions (or teeth) 24c. The alternating magnetic field due to rotation of the rotor 22 within the magnetic or ferromagnetic bridge 24a, 24b generates an alternating voltage in the coil 26. The protrusions 24c are preferably oriented parallel to the rotor axis 22c so as to face the magnetic elements 22b.

The rotor 22a, 22b may comprise a rotor shaft 36a, preferably including a coupling element 36b. The coupling element 36b allows an external mechanical force to be applied on the rotor shaft 36a to generate a rotation of the rotor 22a, 22b around its axis of rotation 22c. The coupling element 36b may be a pinion, a pulley, or the like.

Additionally, the magnetic or ferromagnetic bridge 24a, 24b comprises at least one ball bearing 32a, 32b for mounting the rotor shaft 36a. Possibly, the first bridge element 24a comprises a first of these ball bearings 32a and the second bridge element 24b comprises a second of these ball bearings 24b. As a consequence, the rotation of the rotor 22a, 22b around its axis of rotation 22c is ensured within the structure of the electric generator 20.

Referring now to FIG. 8A-8B, extensions 24d may be added to the magnetic or ferromagnetic bridge 24a, 24b adapted to allow the attachment of the electric generator 20 to any mechanical structure. Such extensions 24d may be arranged independently from any alignment to the coil 26 or its central axis 26a respectively or to the rotor 22a, 22b or its axis of rotation 22c respectively for making the integration of the electric generator 20 easier in any mechanical structure.

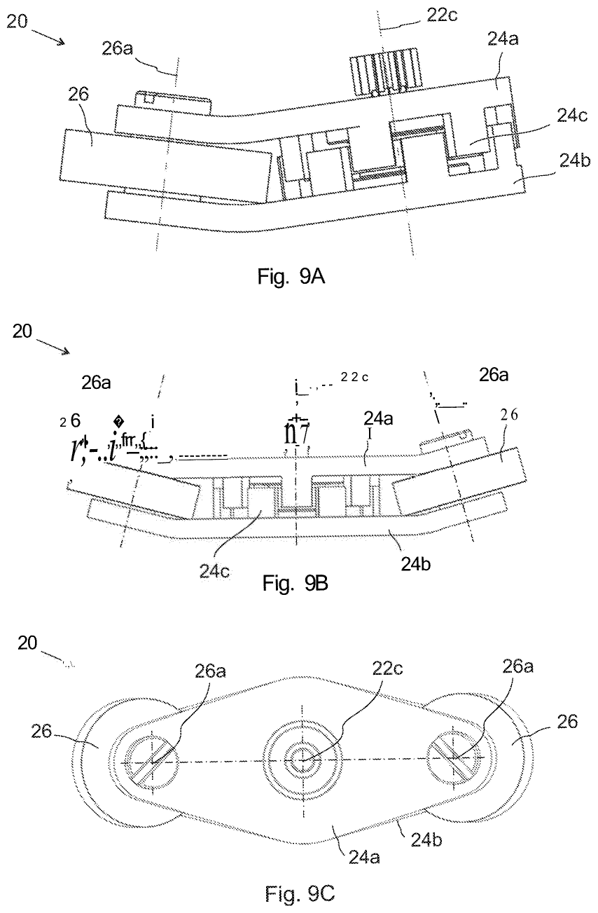

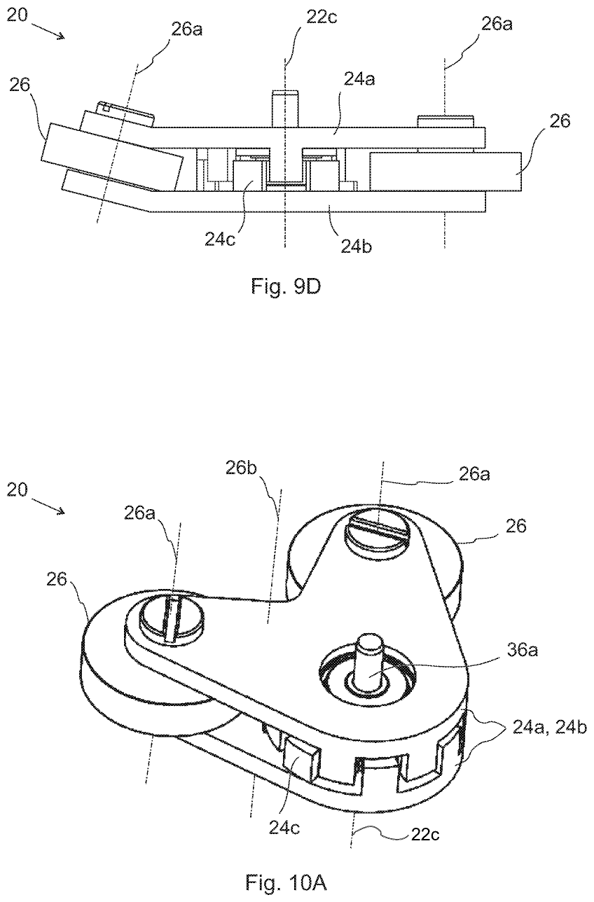

Referring now to FIG. 9A-9C, an electric generator 20 comprises one, optionally two or more coils 26, each having a central axis 26a, more precisely a rotationally central axis, which central axis 26a is non-parallel to the axis of rotation 22c of the rotor, so that the electric generator 20 may appear to be “bent” which, in some applications, allows a better fitting to any mechanical structure.

Referring now to FIG. 9B-9C, an electric generator 20 has two coils 26 installed preferably symmetrically on each side of the rotor. Further extensions of this configuration to accommodate more than two coils 26 around the rotor 22 may also be envisaged and would be considered as belonging to this invention.

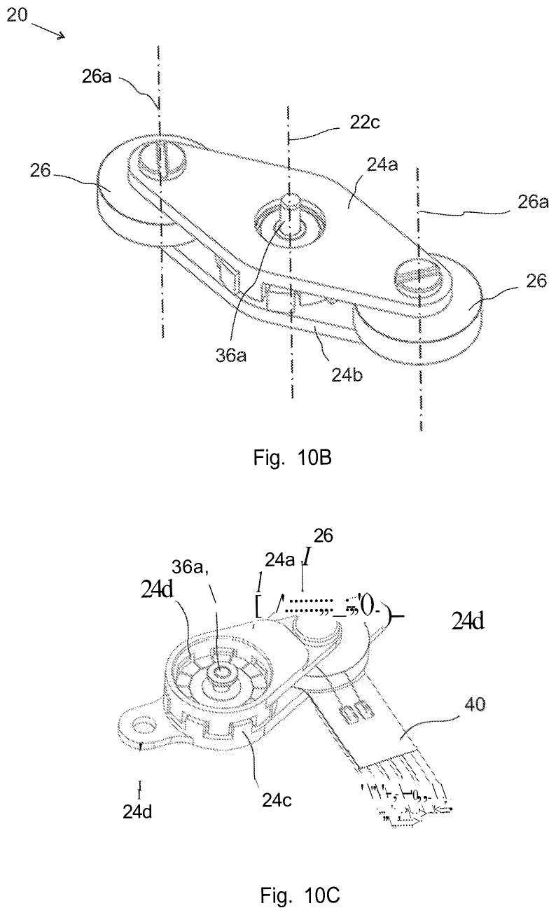

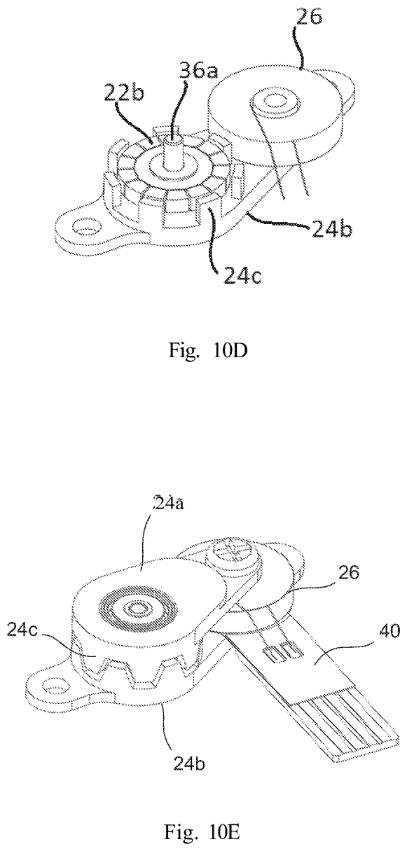

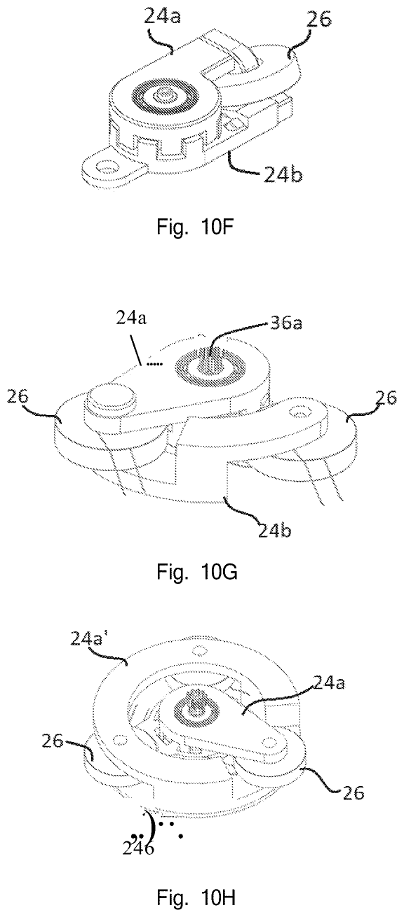

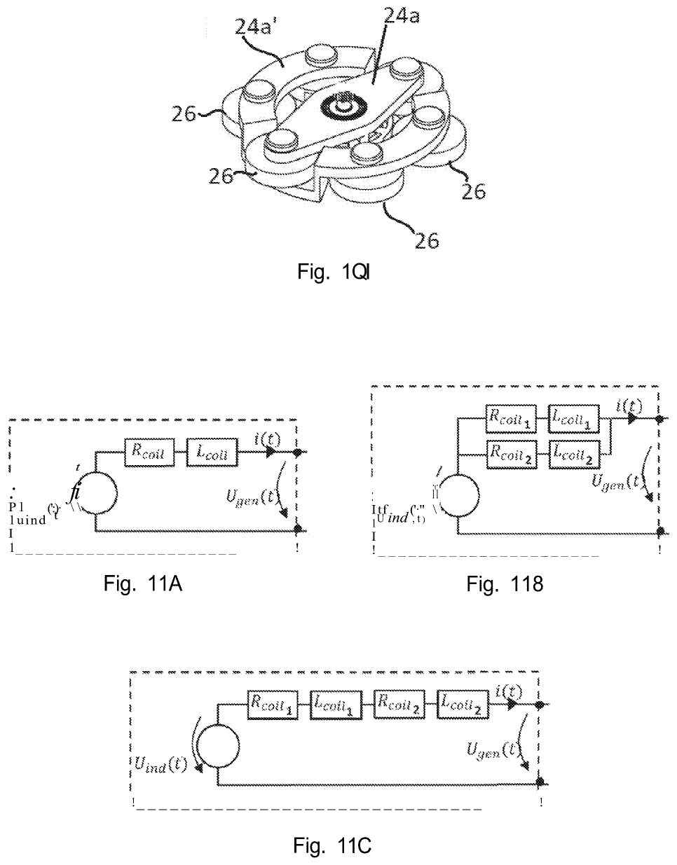

Referring now to FIG. 9D, in another variant, one coil's symmetry axis is parallel to the rotation axis 22c of the rotor 22, and another coil which has its symmetry axis non-parallel to the rotation axis 22c of the rotor 22 (a hybrid of that shown in FIG. 9A and 10A).

In other words, or alternatively, in a similar configuration as shown in the other figures, except we have more than one coil, these coils have their symmetry axis individually non-concentric to the rotor's rotation axis.

Referring now to FIG. 10A-10B, an electric generator 20 may include two or more coils 26 for adapting the electric generator 20 configuration to a minimal or maximal wire cross-section for forming the coil 26. the magnetic or ferromagnetic bridge 24a, 24b, transmits the alternating magnetic field to or from the coils 26. Each of the coils 26 has a central axis 26a.

An overall centroidal axis 26b (i.e., effective centroid of the coil effects) is defined to pass as close as possible through the actual barycenter of all of the central axes 26a, whereby the overall centroidal axis 26b is preferably arranged non-concentrically or non-coaxially to the axis of rotation 22c of the rotor 22. The overall centroidal axis 26b further is arranged so as not to cross the rotor. In other words, the overall centroidal axis 26b is arranged so as to cross, preferably vertically, through the rotation plane 22d of the rotor at a distance from the rotor. This distance is typically between 30% and 300% of the diameter of the rotor 22. Further extensions of this configuration to accommodate more than 2 coils around the rotor 22 may also be envisaged and should be considered as part of this invention. Referring now to FIG. 10B, an overall centroidal axis 26b passes through the geometrical center of all of the central axes 26a, whereby the overall centroidal axis 26b is arranged concentrically or coaxially to the axis of rotation 22c of the rotor 22.

Further extensions of this configuration to accommodate more than 2 coils around the rotor 22 may also be envisaged and would be considered as belonging to this invention.

Referring to Fig. 10C, one or all of the first and second bridge elements 24a, 24b can comprise a through hole 24d allowing to render visible the rotor 22. Such a through hole may have the diameter of the rotor 22 so as to render visible the magnetic elements 22b. Alternatively, the through hole 24d can provide a window rendering visible a portion of the rotor 22. The through hole can be let open or can be closed completely or partly with a transparent cover. The rotation shaft 36a of the rotor can remain free due to the through hole 24d. Alternatively, the rotation shaft can be connected to the corresponding bridge element by means of one or several beams (not represented) to the corresponding bridge element.

Referring to FIG. 10D, the second bridge element 24b is represented as a bottom support for both the rotor 22 and the coil 26.

Referring to FIG. 10E, the teeth or protrusions 24c are represented with a shape different than a square profile. The protrusions can be for example beveled or angled. The shape of the teeth 24c can be adapted according to the needs, in particular with respect to the electromagnetic properties and/or aesthetic properties of the present electric generator.

Referring to FIG. 10F, the coil 26 can be twisted with regard to the corresponding rotor 22. The twist angle between the rotor 22 and the coil 26 can be comprised between 1° and 90°, preferably between 10° and 60°. Typically, the twist angle is comprised between 20° and 40°. The bridge 24a, 24b has an appropriate shape so as to allow the angle position of the coil 26. Alternatively, or in addition, the rotor 22 can be twisted. The first and second bridge elements 24a, 24b can have substantially a flat geometry with a suitable recess to allow the twisted arrangement of the coil or the coils. Alternatively, one or both of the first and second bridge elements 24a, 24b can be themselves twisted.

Referring to FIG. 10G, more than two bridges elements can be provided, in particular in case of two or more coils 26. For example, a first bridge element 24a can be provided between the rotor 22 and a first coil 26, a second bridge element 24b can be provided between the rotor 22 and a second coil 26, and an intermediate bridge can be provided between the first and the second coils 26. Such an intermediate bridge element 24a′ (also see FIG. 10H) can be arranged at a bottom or at a top position of the present electrical generator. Alternatively, an intermediate bridge element 24a′ can be arranged so as to cross the rotation plane 22d. In other words, part of the intermediate bridge element 24a′ can be located at a bottom position of the present electric generator while another part of the intermediate bridge element 24a′ is arranged at a top position of the electric generator. This does not exclude that one or several of the rotor and the coils are twisted.

Referring to FIG. 10H, three coils 26 may be arranged for a given rotor 22, wherein each coil 26 is connected to the rotor 22 by means of at least one bridge element 24a, 24a′, 24b. FIG. 10I shows an arrangement with 6 coils combined to a rotor 22 through several bridge elements 24a, 24a′.

Referring now to FIG. 11A, an electric generator 20 includes one a coil 26 electrically represented as a resistance R_{coil} and an inductance L_{coil} connected in series to the source of induced voltage U_{ind}(t) in the coil. The voltage available at the output of the generator device 20 is named U_{gen}(t), the current provided at the output of the generator device 20 is named i(t).

Referring now to FIG. 11B, electric generator 20 includes at least two coils. The two coils may be connected in parallel. In the connection schematics, R_{coil1} and L_{coil2} represent the resistance and inductance of a first of the coils; R_{coil2} and L_{coil2} represent the resistance and inductance of a second of the coils.

Referring now to FIG. 11C, an electric generator 20 includes at least two coils. These coils may be connected in series. In the connection schematics, R_{coil1} and L_{coil1} represent the resistance and inductance of a first of the coils; R_{coil2} and L_{coil2} represent the resistance and inductance of a second of the coils.

A combination of coils connected in series and in parallel is of course also possible.

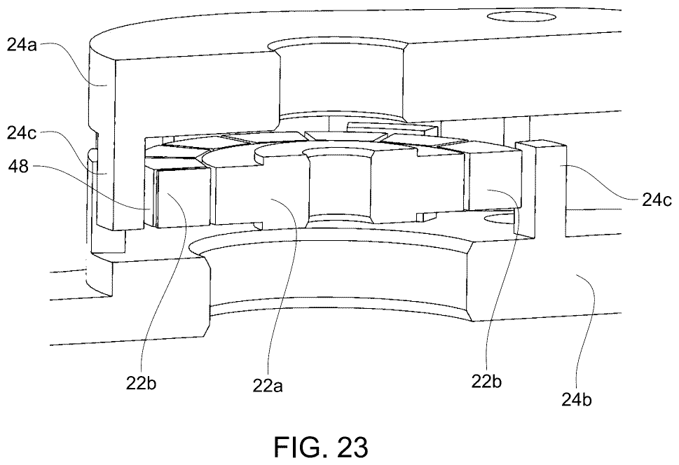

Referring to FIGS. 12-23, the present disclosure relates to a motor or generator or the electric generator device 20 with at least one (1) coil and at least one (1) phase, although the present motor or generator, or the electric generator device 20, can have several coils and at least one phase, e.g. 6 coils and 3 phases. The aspects of the present disclosure are applicable to wearable devices, such as a watch, a wristwatch, a jewellery or a fashion item, although those skilled in the art can contemplate an extension of the applications of the present disclosure to various other articles or items, such as hand-held devices, clocks, styluses, etc.

The electric generator device 20 may include a rotor 22 and a coil 26. The coil 26 may be a fixed coil and the rotor 22 may be a rotating rotor to obtain the electrical output. Conversely, in some embodiments, it is possible that the rotor 22 may be a fixed rotor and the coil 26 may be a rotating coil. In some embodiments, both the rotor 22 and the coil 26 may rotate to obtain the electrical output. In the present disclosure, the rotor 22 may rotate while the coil 26 may be a fixed coil, as a representation of the relative rotation between rotor 22 and the coil 26. Further, while aspects of the present disclosure describe the rotation of the rotor 22 about the axis of rotation 22c with respect to the teeth 24c, in some embodiments, it is possible for the rotor 22 to remain fixed while the teeth 24c may rotate around the rotor 22 for the inducement of the alternating magnetic field within the ferromagnetic bridge 24a, 24b. Also, in some embodiments, it is possible for both the teeth 24c and the rotor 22 to rotate relative to each other about the axis of rotation 22c for the inducement of the alternating magnetic field within the ferromagnetic bridge 24a, 24b. In such cases, structural variations or changes as applicable in the electric generator device 20 may be contemplated by someone skilled in the art based on the aspects described in the present disclosure.

As the rotor 22 rotates, the rotor 22 generates an alternating magnetic field within the surroundings of the rotor 22. This allows the alternating magnetic field, through the ferromagnetic bridge 24a, 24b, to induce electrical voltage within the coil 26. When an electrical load (e.g., resistance, inductance, capacitor, filter, diode rectifier bridge, LED, battery, etc.) is connected to the coil 26, a current circulates within the electrical load as a consequence of the voltage produced by the coil 26, thereby transmitting electrical power to the electrical load. Such an electrical load can be defined by, or may include, a resistance, an inductance, a capacitor, a filter, a diode rectifier bridge, a LED, a battery, or a combination thereof, as described above, or any other device having an electrical characteristic or one that works on electrical power. The electrical load can further include devices or accessories having one or several movable parts, which may be combined as long as such devices or accessories can be moved or activated by an electrical source. Examples of electrical loads are provided in WO2016142765, WO2021152532 or WO2022107072, the contents of which are incorporated by reference.

The present disclosure is based on the realization that the coil 26 is affected by the alternating magnetic field induced within in the ferromagnetic bridge 24a, 24b, and, therefore, the coil 26 does not need to be in the immediate vicinity of the rotor 22. Instead, to be affected by the alternating magnetic field of the rotor 22, the ferromagnetic bridge 24a, 24b is arranged in the vicinity of the rotor 22. For the coil 26 to be affected by the alternating magnetic field of the rotor 22, the ferromagnetic bridge 24a, 24b transmits the alternating magnetic field into the vicinity of the coil 26. Therefore, the ferromagnetic bridge 24a, 24b is needed for electrically coupling the rotor 22 to the coil 26 and for also locally transmitting the alternating magnetic field generated by the rotor 22 to the coil 26 for inducing voltage within the coil 26.

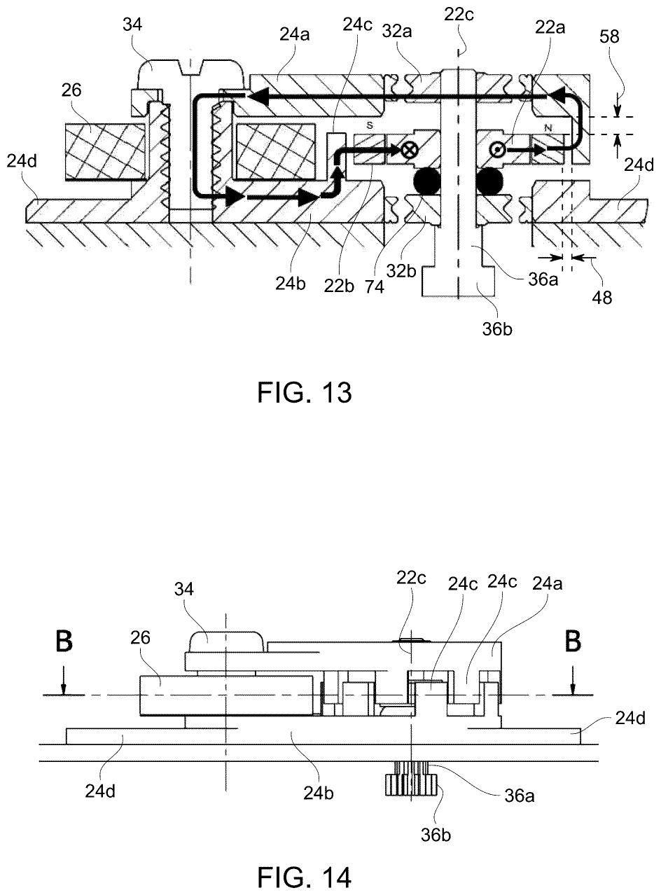

To couple or induce the radial magnetic field of the rotor 22 into the ferromagnetic bridge 24a, 24b, couplers (e.g., teeth 24c) extend from the ferromagnetic bridge 24a, 24b and radially or annularly occupy a space defined concentrically around the rotor 22. A gap (e.g., an annular gap) between the magnetic elements of the rotor 22 and the teeth 24c may be defined and the same may be referred to as the air gap (see air gap 48 in FIG. 13). Although not limited, the teeth 24c may be an integral part of the ferromagnetic bridge 24a, 24b and may be function as couplers to couple the bridge elements 24a, 24b to each other, forming a cylindrical cage-like structure around the rotor 22, as shown, e.g., in FIG. 20.

The ferromagnetic bridge 24a, 24b is shaped to concentrate the magnetic flux from the couplers or teeth 24c towards and through the coil 26. The ferromagnetic bridge 24a, 24b extends cylindrically through the center of the coil 26 and this extension defines an outer diameter of anywhere between 1 to 2 millimetres (mm), preferably 1.4 to 1.5 mm. The cylindrical ferromagnetic bridge extension through the center of the coil 26 can be solid or hollow. The extension can include a thread 34′ for one or more fixing elements or screws, e.g., see screw 34, to pass therethrough and which may be used to rigidly and intimately connect both bridge halves or bridge elements 24a, 24b together or to each other. Alternatively, a pin could be press fitted into the hollow for the connection of both bridge halves or bridge elements 24a, 24b to each other. The couplers or teeth 24c may define a cylindrical inner surface 28 (see FIG. 12) that faces the rotor 22. The cylindrical inner surface 28 may define a diameter that is anywhere within a range of 0.2 to 0.6 mm, preferably between 0.2 and 0.4 mm, and may be larger than the outer diameter of the rotor 22.

The air gap 48 may define a radial distance between the magnetic elements 22b and the couplers or teeth 24c. The radial distance my take any value within a range of 0.1 to 0.3 mm, preferably between 0.1 and 0.2 mm. Further, the coupler or the teeth 24c in a radial direction may define a width ranging anywhere between 0.1 to 0.4 mm or between 0.2 to 0.3 mm. In some embodiments, the radial distance between the magnetic elements 22b affixed to the rotor 22 with its axis of rotation 22c and the bridge couplers or teeth 24c (e.g., the air gap 48) is at least twice as small as an axial distance 58 (see FIG. 13) between the magnetic elements 22b and the ferromagnetic bridge 24a, 24b.

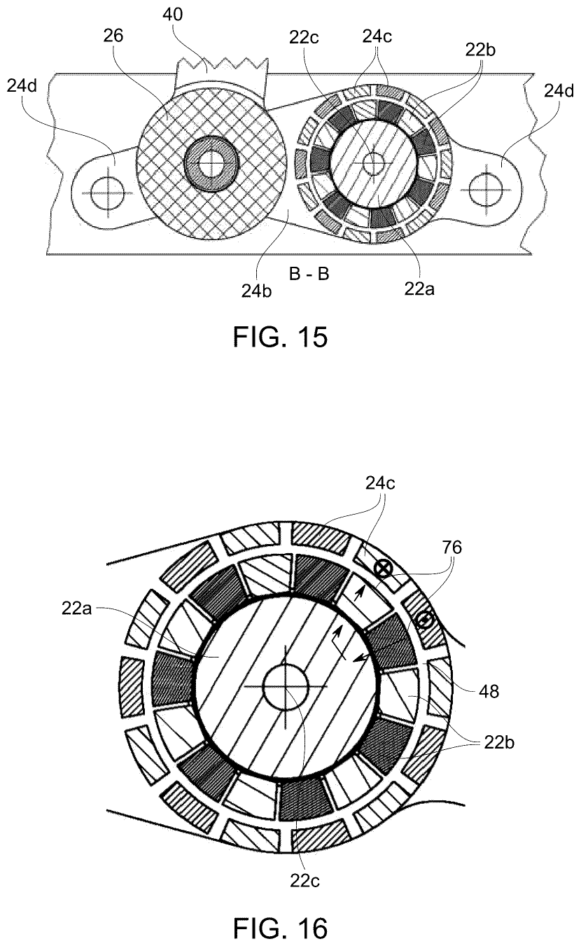

The couplers or teeth 24c are interdigitated between both halves of the magnetic or ferromagnetic bridge 24a, 24b. Also, the total number of couplers or teeth 24c corresponds to double the number of pole pairs 76 (see FIGS. 15 and 16) (also see FIGS. 22A-22C) of the magnetic elements 22b. Further, the number of couplers or teeth 24c may be equally distributed between both bridge halves where one coupler or tooth 24c per half bridge is attributed to one pole. As an example, the bridge element 24a include 7 teeth 24c, and, similarly, the bridge element 24b include 7 teeth 24c, as well. All couplers or teeth 24c per bridge halve or bridge element can be exposed to the same magnetic field direction, which is opposite to the other bridge halve or bridge element, at any given moment.

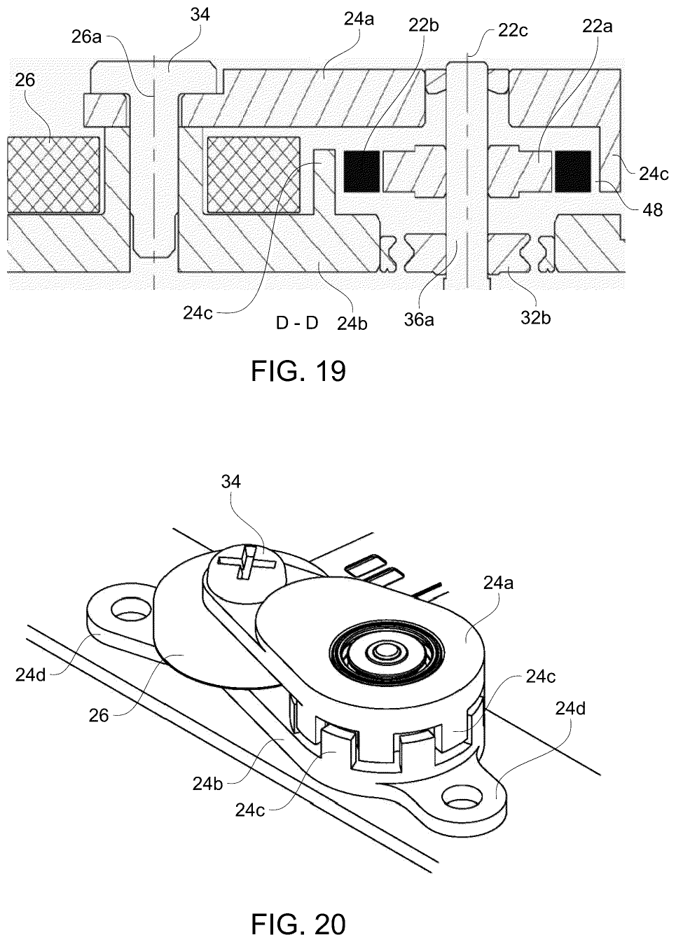

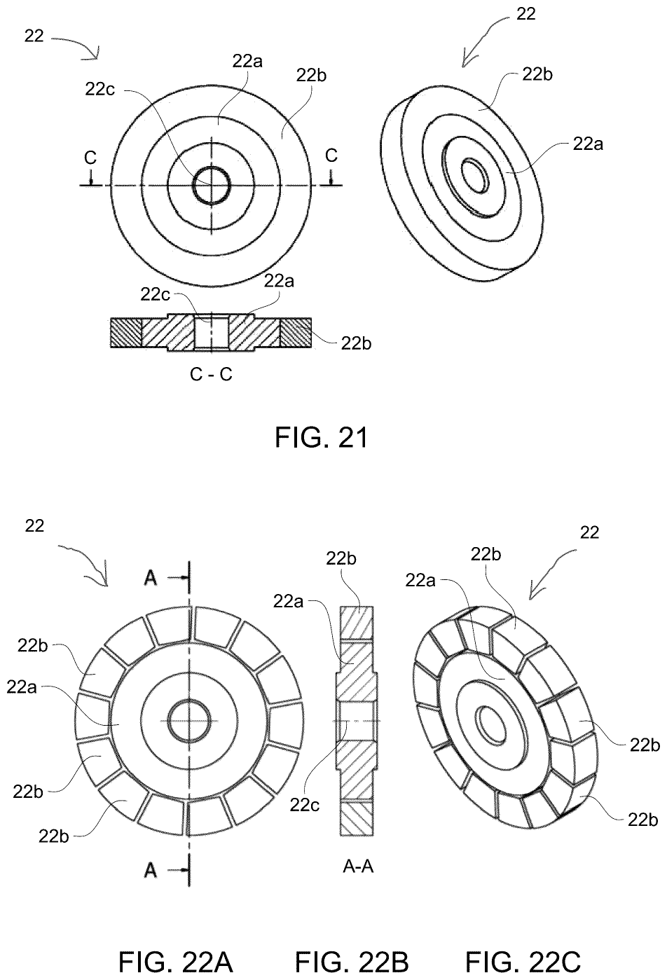

Referring to FIGS. 14-17, the rotor 22 can be disk shaped and can be made of a central ferromagnetic core and the coaxially affixed magnetic elements 22b around the central ferromagnetic core (or yoke) 22a. The ferromagnetic core 22a may have a diameter of 2 to 4 mm, more preferably 2.4 mm. The ferromagnetic core 22a can be machined cylindrical or with a number of facets which may correspond to twice the number of pole pairs. The magnetic elements 22b can at least include one permanent magnet, such as a bonded permanent magnet, preferably sintered permanent magnet in a ring shape radially magnetized into at least one pole pair (also see FIGS. 19 and 21), preferably 4 to 10 pole pairs, and more preferably 7 pole pairs. Further, the magnetic elements 22b may include an axial height anywhere between 0.2 to 0.8 mm, preferably between 0.4 to 0.8 mm, and, more preferably 0.5 mm. The magnetic elements 22b may be separated into individual permanent magnet segments which can be individually magnetized. Also, the magnetic elements 22b may be made of at least one permanent magnet segment preferably made of sintered NdFeB or SmCo or any combination of rare earth magnetic elements with a high maximum energy product ((BH) max) characteristics using a magnetic grade of 10 and above, i.e., with (BH) max>10 MGOe, preferably NdFEB grade>25, even more preferably NdFEB with grade of >40.

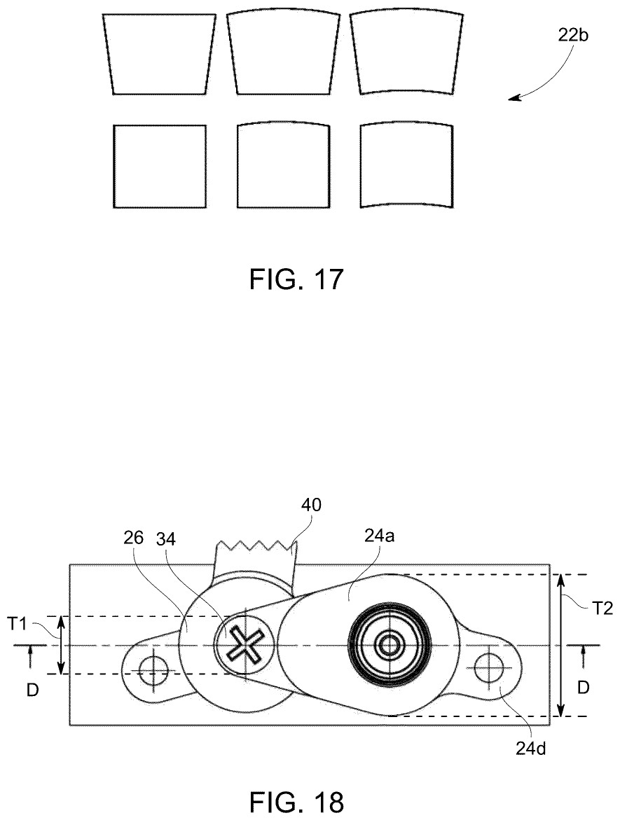

The shape of the magnet segments of the magnetic elements 22b may range from cubes to truncated pie slice shapes (see FIG. 17). These magnet segments can be tiles that resemble cubes to within +20% of a cube's dimensions. A ratio between number of pole pairs and rotor magnetic element external diameter in mm is preferably 2±10%. Further, a ratio between rotor magnetic element external diameter and magnet segment radial dimension is preferably 7±10%. The rotor diameter, including the magnetic elements 22b, can be in the range of 2.5 to 5 mm and may include 4 to 10 pole pairs. In a preferred configuration, the rotor external diameter is 3.5 mm, number of pole pairs is 7 with a central ferromagnetic core diameter of 2.5 mm.

Ratio between bridge-to-bridge dimension and magnet segment dimension in the direction parallel to the axis of rotation 22c is preferably 4 to 6. In a preferred configuration the dimension of the magnet segment parallel to the axis of rotation 22c is anywhere between 0.5 to 0.6 mm and the dimensions between the two bridges is preferably anywhere between 2 to 2.5 mm. The ratio between the magnet segment dimension in the direction parallel to the axis of rotation 22c and air gap dimensions between the magnetic element 22b and bridge elements 24a, 24b in the direction parallel to the axis of rotation 22c is preferably 2. The ratio between the generator short dimension in the rotation plane 22d perpendicular to the axis of rotation 22c and the magnetic element 22b external diameter is 1.3±30%, preferably 1.3±20%, more preferably 1.3±10%, even more preferably 1.3±5%.

To save space, the coil 26 may be self-supported within the ferromagnetic bridge 24a, 24b. Further, the coil 26 may be preferably made of thermo-bonding material, including coated copper wire or electrical wire electrically connected (e.g., directly) to a flat flex printed circuit board (PCB) 40 (see FIGS. 4 and 18), which can connect to the electrical load (not shown). The electrical coil connection to the flat flex PCB 40 can be realized by soldering, thermo-compression welding, ultrasonic welding or other electrical connection means, preferably by soldering, or by other means now known or in the future developed. In another configuration, the coil 26 may be made of precious conductive material, such as, aluminium, gold, silver or other conductive wire. In some embodiments, the coil 26 can come with protective coating and may impart unique decorative features to the electric generator device 20. The cross-sectional area of the coil 26 may be maximized to occupy as much space as possible between the teeth 24c and a core associated with the coil 26 and within a span defined between both bridge halves or the bridge elements 24a, 24b. Also, in some embodiments, the distance between axis of rotation 22c and the center of the cylindrical bridge core can be anywhere between 3 to 6 mm, preferably 4.5 mm.

A number of turns of the coil 26 can depend on a generator working point (e.g., voltage, current, rotor speed, etc.), but are preferably anywhere between 8,000 and 20,000 turns, with nominal generator output electrical power of 5 to 30 milliwatts (mW), and even more preferably 9,000 to 12,000 turns with nominal generator output electrical power of 10 to 30 mW. In a preferred configuration, the rotor speed can be between 5,000 rpm and 15,000 rpm with nominal generator output electrical power of 5 to 25mW.

According to another embodiment of the electric generator device 20, the orientation of the axis of rotation 22c of the rotor 22 is different from the orientation of a central axis 26a of the coil 26. For example, the axis of rotation 22c and the central axis 26a are twisted or non-parallel relative to each other. The coil 26 is to be understood as being substantially arranged, sufficiently symmetrical so as to insure operation, preferably efficient operation of the electric generator device 20. The coil 26 may be formed by a single substantially symmetrical coil. Therefore, the magnetic or ferromagnetic bridge 24a, 24b for transmitting the alternating magnetic field is placeable in between the rotor 22 and the coil 26. Therefore, the magnetic field is transmittable with the help of the magnetic or ferromagnetic bridge 24a, 24b over a significant distance from the rotor 22 to the coil 26.

As described above, a further embodiment of the electric generator device 20 contains at least two coils 26, whereby each coil 26 contains one central axis 26a, whereby an overall centroidal axis 26b passes through the centroid or, more accurately, barycenter (a non-physical center of the combined coil effects and not merely the combined geometrical center), the overall centroidal axis 26b of all of the central axes 26a may be determined (see FIG. 10A). The overall centroidal axis 26b is preferably arranged non-concentrically, non-coaxially and/or non-parallel with respect to the axis of rotation 22c of the rotor 22. Alternatively, or in addition, the overall centroidal axis 26b can be twisted with regard to the axis of rotation 22c of the rotor 22. If there is more than one coil 26, each of the coils 26 may form its own central axis 26a. In other words, the overall centroidal axis 26b or barycenter may therefore be different or non-congruent from the axis of rotation 22c of the rotor 22. Therefore, the electric power may be enhanced in this manner. These at least two coils 26 may be connected in parallel or may be connected in series. Alternatively, the at least two coils 26 can remain non-connected so as to be independent from each other. According to such arrangement, independent electrical load be supplied by each one of the coils 26. The two or more coils 26 may have different sizes and/or number of turns. Different such arrangements are possible, and those may be contemplated by someone skilled in the art based on the present disclosure.

Within a further embodiment of the electric generator device 20, a rotation plane 22d of the rotor 22 is defined, as described above. The rotation plane 22d may be perpendicularly arranged to the axis of rotation 22c of the rotor 22. The central axis 26a of the at least one coil (or the coil 26) passes through the rotation plane 22d at a point different from the intersection of the axis of rotation 22c of the rotor 22 and the rotation plane 22d. Therefore, the arrangement of the coil 26 may be only limited by the ability of the ferromagnetic bridge 24a, 24b to transmit the effect of the alternating magnetic field to the coil 26. According to some arrangements, the rotation plane 22d of the rotor 22 can be parallel to a plane formed by the ferromagnetic bridge 24a, 24b. Such an arrangement is however not essential for the present invention. According to some arrangements, the rotation plane 22d of the rotor 22 can be parallel or identical to a plane orthogonal to the central axis 26a of the coil 26. Such a configuration is however not mandatory. For example, the axis of rotation 22c of the rotor 22 can be twisted with respect to the central axis 26a of the coil 26 so that the rotation plane 22d of the rotor 22 and a plane orthogonal to a central axis 26a of the coil 26 are not parallel. Effectively, the central axis 26a of the coil 26 may be non-parallel to the axis of rotation 22c of the rotor 22. This may provide another possibility to place or position the coil 26 within the electric generator device 20 according to the mechanical structure of the electric generator device 20. It is nevertheless possible for the axis of rotation 22c of the rotor 22 to be parallel to the central axis 26a of the coil 26, as well.

Within a further embodiment of the electric generator device 20, the ferromagnetic bridge 24a, 24b includes materials selected from the group of materials consisting of Fe, Co, Cr and Ni and a metalloid or a combination thereof, preferably C, B, Si, V, M, or an alloy of at least two of these materials. The ferromagnetic bridge 24a, 24b can be treated (e.g., in a way now known or in the future developed) so as to enhance its magnetic properties. For example, heat treatment of the materials of the ferromagnetic bridge 24a, 24b can be considered. In a preferred configuration, the ferromagnetic bridge 24a, 24b are made of machined Nickel-Iron alloy with Ni content of >46%, a saturation induction of Js>1.4 and a permeability μmax>50,000 after annealing process.

Within a further embodiment of the electric generator device 20, the magnetic or ferromagnetic bridge 24a, 24b includes a first bearing 32a and the rotor 22 is pivotally or rotatably mounted at the first bearing 32a. Therefore, the rotor 22 is adjustable and/or movable with respect to the magnetic or ferromagnetic bridge 24a, 24b. Furthermore, the magnetic or ferromagnetic bridge 24a, 24b includes a second bearing 32b and the rotor 22 is pivotally or rotatably mounted at the second bearing 32b. Both the first bearing 32a and the second bearing 32b enable the rotor 22 to efficiently (e.g., freely) rotate with respect to the magnetic or ferromagnetic bridge 24a, 24b when an external mechanical force is transmitted to the rotor 22 through or by way of the coupling element 36b.

The rotor 22 may substantially be arranged between the first bearing 32a and the second bearing 32b, as shown. This allows a higher stability of the rotor 22, when rotating, therefore enabling lower dimensions or sizes of the electric generator device 20 to be employed. The first and/or the second bearings 32a, 32b may be a ball bearing, a friction bearing, preferably a ball bearing equipped with non-magnetic balls (e.g., to remain unaffected from the alternating magnetic field and also refrain from influencing the alternating magnetic field). In some embodiments, the first and second bearings 32a, 32b may include ceramic ball bearings. The rotor 22 may be substantially arranged between the first and second bearings 32a, 32b such that the magnetic elements 22b are rotating between the first and second bearings 32a, 32b. A mechanical transmission solution can be provided to mechanically connect the rotor 22 to the mechanical application (source of mechanical energy) thereby rotating the rotor 22. In some embodiments, the rotor shaft 36a may be equipped with a gear, a pulley, or any mechanical coupling solution to transmit rotary movement to the rotor 22.

The mechanical transmission solution might be placed at the first bearing side or at the second bearing side or at both sides, depending on the application. In case of only one transmission solution, the first bearing 32a located on same side as transmission solution might be a ball bearing, the second bearing 32b that is located on the opposite side might be a sleeve bearing such as a jewel or any other type of sleeve bearing. The electric generator device 20 can be driven by substantially constant mechanical energy. For example, the electric generator device 20 can be driven by a constant torque from a barrel such as those used in horology or several barrels, either in series or in parallel. The present electric generator device 20 may be used for supplying accessories which are not directly activated or moved by mean of a mechanical source.

To electrically connect the coil 26 to the electric load, the ends of the coil 26 may be attached or soldered to wires, or to a connector, or to a rigid or semi-rigid PCB, or to the flat flex PCB 40 or any electric transmission solution allowing to connect the electric generator device 20 to an electric circuit (or an electric load).

In some embodiments of the electric generator device 20, the magnetic or ferromagnetic bridge includes a first bridge element 24a and a second bridge element 24b. The first bridge element 24a includes the first bearing 32a and the second bridge element 24b includes the second bearing 32b. The first and second bridge elements 24a, 24b are intimately attached to each other by a single unique screw 34 engaging with a mating thread 34′, or by a press fitted pin, or welded, or crimped. The first bridge element 24a and the second bridge element 24b may include interlocking elements for preventing rotational displacement of the first bridge element 24a relative to the second bridge element 24b (e.g., around the screw 34) when attached to each other by the unique screw 34 engaged with the mating thread 34′. Alternatively, one could use tooling (not shown) to align and then fix everything in place to allow easy assembling and reducing the dimensions of the electric generator device 20.

Referring now to FIG. 13, the first bridge element 24a defines a first metal junction on which the rotor 22 and the coils 26 can be arranged, being remote from one another. The first bridge element 24a can for example be an upper bridge element, as shown. The second bridge element 24b defines a second metal junction, complementary to the first metal junction, allowing to complete the circuit (see arrows) between the rotor 22, the coil 26, and the first bridge element 24a. The second bridge element 24b can be, for example, a lower bridge element, as shown. The ends of the axis of rotation 22c are retained and/or the rotor 22 or the rotor shaft 36a are joined or affixed or maintained at both the first bridge element 24a and the second bridge element 24b so as to maintain the rotor 22 between the two opposite bridge elements 24a, 24b. In some embodiments, a spacer 74 (see FIGS. 12 and 13) may be positioned between the second bearing 32b and the rotor 22.

Similarly, the centroidal axis 26b, related to the coil 26, are retained, joined, affixed, or maintained, at both the first bridge element 24a and the second bridge element 24b so as to maintain the coil 26 between two opposite bridge elements 24a, 24b. Although the first and second bridge elements 24a, 24b are here mentioned, additional bridge elements may be provided intermediately or non-intermediately to the bridge elements 24a, 24b. The additional bridge elements can be provided so that one or more rotors can create the alternating magnetic field and one or more coils can be provided for the inducement of the alternating magnetic field and the generation of electrical output.

Within a further embodiment of the electric generator device 20, the magnetic or ferromagnetic bridge 24a, 24b can include at least one extension (e.g., see extensions 24d) for attaching the electric generator device 20 to any mechanical structure.

According to an embodiment, one or more of the bridge elements 24a, 24b can include a transparent part or an aperture to allow access and visibility of at least a part of the rotor 22, therethrough.

Further, the teeth 24c may be oriented orthogonally to a plane that corresponds or is defined by a corresponding bridge element, i.e., one of the bridge elements 24a, 24b, to which the teeth 24c is connected to (e.g., integrally). In this case, the magnetic elements 22b of the rotor 22 are oriented radially with regard to the rotor 22 and to the axis of rotation 22c of the rotor 22. Alternatively, the teeth 24c can be oriented angularly or orthogonally with respect to a plane of the corresponding bridge element 24a, 24b. In this case, the magnetic elements 22b may be oriented so as to be superimposed to or overlap the teeth 24c. Alternatively, the teeth 24c may form an angle with the plane of the corresponding bridge element different from 90° and 0°. In this case, the magnetic elements 22b of the rotor 22 may be bevelled and oriented so as to face the teeth 24c of each of the first bridge element 24a and the second bridge element 24b.

The teeth geometry can be adapted so as to have a non-squared shape. For example, see examples of the magnetic elements 22b provided in FIG. 17. The number of teeth 24c can be adapted to the needs and/or area of application. The number of teeth 24c can be for example not equal to the number of magnet poles of the rotor 22. A difference of 1 or 2 or more than 2 can be provided between the number of teeth 24c and the number of magnetic elements 22b. Further, the air gap 48 between the teeth 24c and the rotor 22 can be adapted based on one or more aspects described in the present disclosure. Also, the magnetic bridge material is selected so as to adapt the corresponding magnetic properties.

In an advantage, the invention saves space by having essentially the same width but reducing height by virtue of a de-axed design.

In an advantage, the invention is more versatile, allowing a designer to implement the motor device or the electric generator device 20 or a part of it either horizontally or vertically, or with another orientation.

In an advantage, the invention has improved performance due to use of powerful sintered permanent magnets.

It is a further advantage that the present solution allows to provide an energy source different from the main mechanical energy source for accessories not directly activated by the main mechanical energy source. This is done with no increase of hindrance or with a limited increase of hindrance compared to known solutions.

In an advantage, the electric generator device 20 may include a stand-alone rotor module without requiring an external bridge or having an adaptive working point.

In an advantage, the electric generator device 20 can be easily customized by adapting the outer shape and the fixation or the finishing aesthetics of any device or housing it is accommodated in.

In an advantage, the electric generator device 20 has simple components.

In an advantage, the electric generator device 20 allows for avoiding relying on a single source, e.g., a single power source.

In an advantage, the electric generator device 20 allows for machined ferromagnetic or magnetic stainless-steel bridges that provide an adaptive working point, an adaptive interface and customizable design.

It should be appreciated that the particular implementations shown and herein described are representative of the invention and its best mode and are not intended to limit the scope of the present invention in any way. The above-described embodiments are not construed to be mutually exclusive. They can be combined partly or entirely under the limits of the technical feasibility.

It should be appreciated that many applications of the present invention may be formulated.

As will be appreciated by skilled artisans, the present invention may be embodied as a system, a device, or a method.

The invention can be summarized as including elements selected from one or a portion of one of the appended claims or one or a portion of one of the following feature sets:
1. An electric generator device (20) comprising:
at least one rotor (22) having an axis of rotation (22c) and comprising one or more magnetic elements (22b) disposed around the axis of rotation (22c) on the rotor yoke (22a), the one or more magnetic elements (22b) defining pole pairs adapted to create an alternating magnetic field when rotated around the axis of rotation (22c);
at least one coil (26), having a central axis (26a), said at least one coil (26) being remote from said at least one rotor (22) such that the coil is located non-coaxial with, offset from or away from a direct influence of the alternating magnetic field such that central axis (26a) is outside an envelope of the rotor, and
a magnetic or ferromagnetic bridge, comprising at least a first and second bridge elements (24a, 24b) joining said at least one rotor (22) to said at least one coil (26), said at least first and second bridge elements (24a, 24b) comprising couplers in form of protrusions or teeth (24c) in the vicinity of and located to encircle said one or more magnetic elements (22b) so that a voltage within the at least one coil (26) is induced due to the alternating magnetic field within said magnetic or ferromagnetic bridge (24a, 24b) caused by the rotation of the one or more magnetic elements (22b) around the axis of rotation (22c), wherein
   the protrusions or teeth (24c) are interdigitated between both halves of the magnetic or ferromagnetic bridge (24a, 24b) and a total number of the protrusions or teeth (24c) corresponds to double the number of pole pairs defined by the one or more magnetic elements (22b).
2. The electric generator device (20) of feature set 1, wherein
said first bridge element (24a) forms a first plane orthogonal to said axis of rotation (22c), said second bridge element (24b) forms a second plane orthogonal to said axis of rotation (22c), and wherein the teeth of the first bridge element (24a) and the teeth of the second bridge element (24b) are arranged at an angle orthogonal to the corresponding first and second planes around the at least one rotor (22), said one or more magnetic elements (22b) being arranged radially to the at least one rotor (22) to face the teeth of each of the first bridge element and the second bridge element, and
a thickness of one or both of the first and second bridge elements (24a, 24b) decreases from the at least one rotor (22) to the at least one coil (26).
3. The electric generator device (20) of any one of feature sets 1 to 2, wherein the at least one rotor (22) forms a rotation plane (22d) orthogonal to the axis of rotation (22c) and comprises a rotor shaft (36a), one end of said rotor shaft (36a) comprising a coupling element (36b) adapted to transmit an external mechanical force to the at least one rotor (22) to rotate the at least one rotor (22) around the axis of rotation (22c).
4. The electric generator device (20) of any one of feature sets 1 to 3, wherein the central axis (26a) of the at least one coil (26) is non-parallel or non-coaxial to the axis of rotation (22c) of the at least one rotor (22) so that said central axis is twisted with respect to the axis of rotation (22c).
5. The electric generator device (20) of any one of feature sets 1 to 4 comprising at least two coils (26), whereby each coil (26) contains one central axis (26a), whereby an overall centroidal axis (26b) passes through the overall geometrical center, or barycenter, of all of the central axes (26a), whereby the overall centroidal axis (26b) is arranged non-concentrically and/or non-parallel with respect to the axis of rotation (22c) of the at least one rotor (22).
6. The electric generator device (20) of any one of feature sets 1 to 5, wherein the magnetic or ferromagnetic bridge (24a, 24b) includes material selected from one of a group of materials consisting of Fe, Co, Cr or Ni and a metalloid, preferably C, B, Si, V, M or an alloy of at least two of these materials.
7. The electric generator device (20) of any one of feature sets 1 to 6, whereby the first bridge element (24a) comprises a first bearing (32a) and the second bridge element (24b) comprises a second bearing (32b), the first and the second bridge elements (24a, 24b) are attached to each other by one or more screws (34) engaging with a mating thread (34′), whereby the first bridge element (24a) and the second bridge element (24b) each comprise interlocking elements for preventing rotational displacement of the first bridge element (24a) to the second bridge element (24b) when attached to each other by the one or more screws (34) engaging with the mating thread (34′).
8. The electric generator device (20) of any one of feature sets 1 to 7, whereby the magnetic or ferromagnetic bridge (24a, 24b) comprises at least one extension (24d) for attaching the electric generator device (20) to any mechanical structure.
9. The electric generator device (20) of any one of feature sets 1 to 8, comprising at least two coils (26), wherein said at least two coils, or some of them, are connected in parallel, or wherein said at least two coils, or some of them, are connected in series.
10. The electric generator device (20) according to one of feature sets 1 to 9, comprising a plurality of coils and at least one phase.
11. The electric generator device (20) according to one of feature sets 1 to 10, comprising at least one coil (26) and a rotor (22) rotating relative to the coil or a rotor (22) and at least one coil (26) rotating relative to one another or at least one coil (26) and rotor (22), both rotating.
12. The electric generator device (20) according to one of feature sets 1 to 11, wherein, when rotating relative to the at least one coil, the rotor generates an alternating magnetic field within the surroundings of the rotor, thus creating an alternating magnetic field passing through the ferromagnetic bridges, thereby inducing electrical voltage within the at least one coil.
13. The electric generator device (20) according to one of feature sets 1 to 12, wherein, when an electrical load is connected to the at least one coil, a current circulates within the electrical load as a consequence of the voltage produced by the at least one coil, thereby transmitting electrical power to the electrical load.
14. The electric generator device (20) according to feature set 13, wherein the electrical load is defined by, or comprises a resistance, an inductance, a capacitor, a filter, a diode rectifier bridge, a LED, a battery, or a combination thereof, or any other device having an electrical characteristic.
15. The electric generator device (20) according to one of feature sets 13 or 14, wherein the electrical load further comprises devices or accessories having one or several movable parts, which may be optionally combined with lights, as long as such device or accessories can be activated by an electrical source.
16. The electric generator device (20) according to any one of the foregoing feature sets, wherein because the at least one coil is in the vicinity of the rotor, the at least one coil is affected by the alternating magnetic field located in the ferromagnetic bridge.
17. The electric generator device (20) according to any one of the foregoing feature sets, wherein, the ferromagnetic bridge locally transmits the alternating magnetic field generated by the rotor to the at least one coil for inducing voltage within the at least one coil.
18. The electric generator device (20) according to any one of the foregoing feature sets, wherein couplers in form of protrusions or teeth which extend radially couple the radial magnetic field of the rotor into the magnetic or ferromagnetic bridge allowing a certain free space around the concentrically located rotor, and are an integral part of the ferromagnetic bridges.
19. The electric generator device (20) according to feature set 18, wherein the couplers form a cylindrical cage-like structure.
20. The electric generator device (20) according to any one of feature sets 18 or 19, wherein the ferromagnetic bridge is shaped to concentrate the magnetic flux from the couplers towards and through the coil.
21. The electric generator device (20) according to any one of the foregoing feature sets, wherein the ferromagnetic bridge extends via a cylindrical extension of the ferromagnetic bridge through the center of the coil and this extension has an outer diameter of 1 to 2 mm, preferably 1.4 to 1.5 mm.
22. The electric generator device (20) according to the foregoing feature set, wherein the cylindrical extension through the center of the at least one coil is solid.
23. The electric generator device (20) according to any one of feature sets 20 or 21, wherein the cylindrical extension through the center of the at least one coil comprises a hollow portion, optionally comprising a thread for a screw used to rigidly and intimately connect both bridge halves or a pin press fit into the hollow for the connection of both bridge halves.
24. The electric generator device (20) according to any one of the foregoing feature sets, wherein the couplers have a cylindrical inner surface facing the rotor which has a diameter that is of the range of 0.2 to 0.6 mm, preferably between 0.2 and 0.4 mm larger than the outer diameter of the rotor.
25. The electric generator device (20) according to any one of the foregoing feature sets, wherein an air gap between the at least one magnetic elements and the couplers is in the range of 0.1 to 0.3 mm, preferably between 0.1 and 0.2 mm.
26. The electric generator device (20) according to any one of the foregoing feature sets, wherein, in the radial direction, the couplers have a width of 0.1 to 0.4 mm, preferably 0.2 to 0.3 mm.
27. The electric generator device (20) according to any one of the foregoing feature sets, wherein the couplers, being of a quantity comprising a total number, are interdigitated between both halves of the bridge and the total number of couplers which corresponds to double the number of pole pairs of the at least one magnetic elements.
28. The electric generator device (20) according to any one of the above feature set, wherein the number of couplers is equally distributed between both bridge halves where one coupler per half bridge is attributed to one pole.
29. The electric generator device (20) according to feature set 18, wherein all couplers per bridge half are exposed to the same magnetic field direction which is opposite to the other bridge half at any given moment.
30. The electric generator device (20) according to any one of the foregoing feature sets, wherein the at least one magnetic elements affixed to the rotor with its rotation axis and the bridge couplers are disposed at a radial distance from each other and that radial distance comprises an air gap and is at least twice as small as an axial distance between the at least one magnetic element and the bridge.
31. The electric generator device (20) according to any one of the foregoing feature sets, wherein the rotor is disk shaped and includes a central ferromagnetic core (22a) on which the at least one magnetic element is coaxially affixed.
32. The electric generator device (20) according to any one of the foregoing feature sets, wherein the ferromagnetic core (22a) has a preferred diameter of 2 to 4 mm, more preferably 2.4 mm and is optionally a machined cylinder or has a number of facets corresponding to twice a number of pole pairs.
33. The electric generator device (20) according to any one of the foregoing feature sets, wherein the at least one magnetic element has at least one permanent magnet, such as a bonded permanent magnet, preferably sintered permanent magnet in a ring shape radially magnetized into at least one pole pair, preferably 4 to 10 pole pairs and more preferably 7 pole pairs.
34. The electric generator device (20) according to any one of the foregoing feature sets, wherein the at least one magnetic element has an axial height of 0.2 to 0.8 mm, preferably 0.4 to 0.8 mm height and more preferably 0.5 mm height.
35. The electric generator device (20) according to any one of the foregoing feature sets, wherein the at least one magnetic element is separated into individual permanent magnet segments which are individually magnetized.
36. The electric generator device (20) according to any one of the foregoing feature sets, wherein the at least one magnetic element is made of at least one permanent magnet segment preferably made of sintered NdFeB or SmCo or any combination of rare earth magnets with a high maximum energy product ((BH)max) characteristics using a magnetic grade of 10 and above, i.e. with (BH)max>10 MGOe, preferably grade>25, even more preferably with grade of >40.
37. The electric generator device (20) according to any one of the foregoing feature sets, wherein the shape of the magnet segments range from cubes to truncated pie slice shape, the magnets are preferably tiles that resemble cubes to within ±20% of a cube's dimensions.
38. The electric generator device (20) according to any one of the foregoing feature sets, wherein the ratio between a number of pole pairs and an external diameter of the at least one magnetic element of the rotor in millimeters is preferably 2±10%.
39. The electric generator device (20) according to any one of the foregoing feature sets, wherein the ratio between an external diameter of the magnetic elements of the rotor and a radial dimension of the magnet segments is preferably 7±10%.
40. The electric generator device (20) according to any one of the foregoing feature sets, wherein the rotor has a characteristic diameter and the diameter including the at least one magnetic element is in the range of 2.5 to 5 mm and has 4 to 10 pole pairs, or more preferably, the rotor external diameter is 3.5 mm, a number of pole pairs is 7 with a central ferromagnetic core diameter of 2.5 mm.
41. The electric generator device (20) according to any one of the foregoing feature sets, wherein the ratio between a bridge-to-bridge dimension and a dimension of the magnet segment in the direction parallel to the rotor axis (22c) is preferably 4 to 6.
42. The electric generator device (20) according to any one of the foregoing feature sets, wherein, preferably, a dimension of the magnet segment parallel to the rotor axis (22c) in 0.5 to 0.6 mm and a dimension between 2 bridges is preferably 2 to 2.5 mm.
43. The electric generator device (20) according to any one of the foregoing feature sets, wherein the ratio between a dimension of the magnet segment in the direction parallel to the rotor axis (22c) and a dimension of the air gap between the at least one magnetic element of the rotor and bridges in the direction parallel to the rotor axis is preferably 2.
44. The electric generator device (20) according to any one of the foregoing feature sets, wherein the ratio between a short dimension of the generator in the plane perpendicular to the rotor axis (22c) and an external diameter of the at least one magnetic element is 1.3±30%, preferably 1.3±20%, more preferably 1.3±10%, even more preferably 1.3±5%
45. The electric generator device (20) according to any one of the foregoing feature sets, wherein to save space, the coil is self-supported preferably made of thermo bonding material coated copper wire, or electrical wire, directly electrically connected to a flat flex PCB, which connects to the electrical load.
46. The electric generator device (20) according to any one of the foregoing feature sets, wherein the connection of the electrical coil to the flat flex PCB can be realized by soldering, thermo-compression welding, ultrasonic welding or other electrical connection means, preferably by soldering.
47. The electric generator device (20) according to any one of the foregoing feature sets, wherein, the coil is made of a precious conductive material such as, aluminum, gold, silver or other conductive wire, in some cases, with protective and/or decorative coating.
48. The electric generator device (20) according to any one of the foregoing feature sets, wherein a cross-section area of the coil is maximized to occupy as much space as possible between coupler teeth of the magnetic or ferromagnetic bridge and coil core distance and the distance between both bridge halves.
49. The electric generator device (20) according to any one of the foregoing feature sets, wherein the cylindrical bridge core of the coil has a distance between the rotor axis (22c) and the center of the core is 3 to 6 mm, preferably 4.5 mm.
50. The electric generator device (20) according to any one of the foregoing feature sets, wherein the number of turns of the coil depends on the generator running conditions such as voltage, current, or rotor speed.
51. The electric generator device (20) according to any one of the foregoing feature sets, wherein the number of turns on the coil are preferably between 800 and 1′500 turns with nominal generator output electrical power of 5 to 30 mW and even more preferably 900 to 1′200 turns with nominal generator output electrical power of 10 to 30 mW.
52. The electric generator device (20) according to any one of the foregoing feature sets, wherein preferably the rotor speed is between 5′000 rpm and 15′000 rpm with nominal generator output electrical power of 5 to 25 mW.
53. The electric generator device (20) according to any one of the foregoing feature sets, wherein an orientation of the rotor axis (22c) is different from an orientation of a central axis of the coil, whereby the rotor axis and the central axis are twisted or non-parallel.
54. The electric generator device (20) according to any one of the foregoing feature sets, wherein the coil is symmetrical so as to ensure operation, preferably efficient operation of the generator.
55. The electric generator device (20) according to any one of the foregoing feature sets, wherein the coil is formed by a single substantially symmetrical coil.
56. The electric generator device (20) according to any one of the foregoing feature sets, wherein the ferromagnetic bridge for transmitting the alternating magnetic field is disposed in between the rotor and the coil, thereby allowing the magnetic field to be transmittable with the help of the ferromagnetic bridge over a significant distance from the rotor to the coil.
57. The electric generator device (20) according to any one of the foregoing feature sets, containing at least two coils, whereby each coil contains one central axis, whereby an overall central axis passes through the centroid or, more accurately, barycenter (a non-physical center of the combined coil effects and not merely the combined geometrical center), the overall geometric center of all of the central axes may be determined.
58. The electric generator device (20) according to the above feature set, wherein the overall central axis is preferably arranged non-concentrically, non-coaxially and/or non-parallel with respect to the axis of rotation of the rotor.
59. The electric generator device (20) according to feature set 47, wherein the overall central axis is twisted with regard to the axis of rotation of the rotor.
60. The electric generator device (20) according to any one of the foregoing feature sets, wherein, when, in the case that there is more than one coil, each of the coils form its own central axis.
61. The electric generator device (20) according to the above feature set, wherein the overall central axis or barycenter is different or non-congruent with the axis of rotation of the rotor.
62. The electric generator device (20) according to feature set 50, wherein the coils are connected in parallel.
63. The electric generator device (20) according to feature set 50, wherein the coils are connected in series.
64. The electric generator device (20) according to feature set 50, wherein the at least two coils can remain non-connected so as to be independent from each other such that independent electrical load is supplied by each one of the coils
65. The electric generator device (20) according to feature set 63, wherein the two or more coils may have different sizes and/or numbers of turns.
66. The electric generator device (20) according to any one of the above feature sets, wherein a rotation plane of the rotor is defined, the rotation plane being perpendicularly arranged to the axis of rotation of the rotor, wherein the central axis of the at least one coil passes through the rotation plane at a point different from the intersection of the axis of rotation of the rotor and the rotation plane.
67. The electric generator device (20) according to feature set 65, wherein the arrangement of the at least one coil is limited by the ability of the magnetic or ferromagnetic bridge to transmit the effect of the alternating magnetic field to the at least one coil.
68. The electric generator device (20) according to any one of the above feature sets, wherein the rotational plane of the rotor is parallel to a plane formed by the bridge.
69. The electric generator device (20) according to any one of the above feature sets, wherein the rotation plane of the rotor can be parallel to or co-planar with a plane orthogonal to the central axis of a coil.
70. The electric generator device (20) according to any one of the above feature sets, wherein the axis of rotation of the rotor is twisted with regard to the central axis of a rotor so that the rotation plane of the rotor and a plane orthogonal to a central axis of a coils are not parallel.
71. The electric generator device (20) according to any one of the above feature sets, wherein the central axis of the coil may be non-parallel to the rotor axis (22c)
72. The electric generator device (20) according to any one of the above feature sets, wherein the ferromagnetic bridge contains materials selected from the group of materials consisting of Fe, Co, Cr and Ni and a metalloid or a combination thereof, preferably C, B, Si, V, M, or an alloy of at least two of these materials and is optionally treated to enhance its magnetic properties
73. The electric generator device (20) according to any one of the above feature sets, wherein, preferably, the magnetic or ferromagnetic bridges are made of machined Nickel-Iron alloy with Ni content of >46%, a saturation induction of Js>1.4 and a permeability μmax>50′000 after annealing process.
74. The electric generator device (20) according to any one of the above feature sets, wherein the ferromagnetic bridge comprises a first bearing whereby the rotor is pivotally or rotatably mounted at the first bearing.
75. The electric generator device (20) according to any one of the above feature sets, wherein the ferromagnetic bridge may comprise a second bearing, whereby the rotor is pivotally or rotatably mounted at the second bearing.
76. The electric generator device (20) according to any one of the above feature sets, wherein the rotor is disposed between the first bearing and the second bearing, thus allowing a higher stability of the rotor, when rotating, and consequently enabling smaller dimensions of the electric generator.
77. The electric generator device (20) according to the above feature set, wherein the first and/or the second bearing may be a ball bearing, a friction bearing, preferably a ball bearing equipped with non-magnetic balls, more preferably a ceramic ball bearing.
78. The electric generator device (20) according to any one of the above feature sets, wherein the rotor is disposed between the first and second bearing means such that the at least one magnetic element is rotating between the first and second bearing.
79. The electric generator device (20) according to any one of the above feature sets, wherein the rotor is made up of a rotor shaft and a coupling element allowing an external mechanical force to be applied on the rotor shaft to generate a rotation of the rotor.
80. The electric generator device (20) according to any one of the above feature sets, wherein a mechanical transmission is provided to mechanically connect the rotor to the mechanical application (source of mechanical energy).
81. The electric generator device (20) according to any one of the above feature sets, wherein the rotor shaft is equipped with a gear, a pulley, or any mechanical coupling solution to transmit rotary movement.
82. The electric generator device (20) according to feature set 79, wherein the mechanical transmission is placed at a side of the first bearing or the second bearing or at both sides, depending on the application.
83. The electric generator device (20) according to any one of feature sets 79 to 81, wherein, in case of a single mechanical transmission, the first bearing located on a same side as the mechanical transmission is a ball bearing, the second bearing that is located on the opposite side is a sleeve bearing such as a jewel or any other type of sleeve bearing.
84. The electric generator device (20) according to any one of the above feature sets, wherein, to electrically connect the coil to the electric load, the coil ends are attached or soldered to wires, or to a connector, or to a rigid or semi-rigid PCB, or to a Flex PCB or any electric transmission means allowing connection of the device to an electric circuit (electric load).
85. The electric generator device (20) according to any one of the above feature sets, wherein the device is driven by substantially constant mechanical energy such as a constant torque from a barrel or several barrels, either in series or in parallel.
86. The electric generator device (20) according to any one of the above feature sets, wherein the ferromagnetic bridge contains a first bridge element and a second bridge element, whereby the first bridge element comprises the first bearing and the second bridge element comprises the second bearing, the first and the second bridge elements are intimately attached to each other, by a single unique screw engaging with a mating thread, or by a press fitted pin, or welded, or crimped, whereby the first bridge element and the second bridge element each preferably comprise interlocking elements for preventing rotational displacement of the first bridge element to the second bridge element when attached to each other by the unique screw engaging with the mating thread.
87. The electric generator device (20) according to any one of the above feature sets, wherein a first bridge element designates a first metal junction on which the rotor and the coils are disposed, being remote, namely, either offset from or non-coaxial to one another.
88. The electric generator device (20) according to the above feature set, wherein a first bridge element is preferably an upper bridge element and, optionally, a second bridge element designates a second metal junction, in complement of the first metal junction, allowing completion of the circuit between the rotor, the coils and the first bridge element, and wherein further, the second bridge element is optionally a lower bridge element, the ends of the rotor axis (22c) being joined or affixed or maintained at both the first bridge element and the second bridge element so as to maintain the rotor between two opposite bridge elements.
89. The electric generator device (20) according to any one of the above feature sets, wherein the ends of a central axis, related to a coil, are joined to or affixed or maintained at both the first bridge element and the second bridge element so as to maintain the coil between two opposite bridge elements.
90. The electric generator device (20) according to the above feature set, wherein two opposite bridge elements join all rotors and coils.
91. The electric generator device (20) according to any one of the above feature sets, wherein the ferromagnetic bridge comprises at least one extension for attaching the electric generator device to any mechanical structure.
92. The electric generator device (20) according to any one of the above feature sets, wherein a bridge element comprises a transparent part or an aperture to allow the visibility of the rotor or part of it.
93. The electric generator device (20) according to any one of the above feature sets, wherein the teeth of the stator are oriented orthogonally to a plane corresponding to the plane of the corresponding bridge element.
94. The electric generator device (20) according to the above feature set, wherein the magnetic field of the at least one magnetic element of the rotor is oriented radially with regard to the axis of rotation of the rotor.
95. The electric generator device (20) according to any one of the above feature sets 1 to 83, wherein the couplers are oriented in the plane corresponding to a plane of the corresponding bridge element such that the at least one magnetic element is oriented so as to be superimposed to the teeth.
96. The electric generator device (20) according to any one of the above feature sets 1-83, wherein the teeth form an angle with the plane of the corresponding bridge element different from 90° and 0°, wherein further, the at least one magnetic element of the rotor is optionally beveled and oriented so as to face the teeth.
97. The electric generator device (20) according to any one of the above feature sets, wherein the couplers geometry is adapted so as to have a non-square shape.
98. The electric generator device (20) according to feature set 42, wherein the air gap between couplers and the rotor is increased relative to the said dimension.
99. The electric generator device (20) according to any one of the above feature sets, wherein the number of couplers is not equal to the number of magnet poles of the rotor, being no more than one or two more teeth different.
100. The electric generator device (20) according to any one of the above feature sets, wherein the magnetic bridge material is selected so as to adapt the corresponding magnetic properties.
101. The electric generator device (20) of any one of the foregoing feature sets, wherein the one or more magnetic elements (22b) are affixed to the at least one rotor (22) and are spaced apart from the teeth to define a radial distance or an air gap with the teeth, wherein the radial distance is constant around the axis of rotation and is at least twice as small as an axial distance between the one or more magnetic elements (22b) and the magnetic or ferromagnetic bridge, and the air gap is defined anywhere within a range of 0.1 to 0.3 millimetres (mm) or within a range of 0.1 and 0.2 mm.
101. The electric generator device (20) of any one of the foregoing feature sets, wherein each of the teeth, along the radial distance, has a width ranging anywhere between 0.1 to 0.4 mm or between 0.2 to 0.3 mm.
102. The electric generator device (20) of any one of the foregoing feature sets, wherein
   the magnetic element includes at least one permanent magnet in a ring shape, the at least one permanent magnet being radially magnetized into at least one pole pair, the at least one permanent magnet including at least one of a bonded permanent magnet or a sintered permanent magnet, and
   the pole pairs associated with the magnetic element correspond to anywhere between 4 to 10 pole pairs or to 7 pole pairs.
103. A wearable device including the electric generator device (20) according to one of the preceding feature sets.

An electric generator device 20 includes at least one rotor 22 having an axis of rotation 22c and comprising one or more magnetic elements 22b disposed around the axis of rotation 22c. The magnetic elements 22b define pole pairs adapted to create an alternating magnetic field when rotated around the axis of rotation 22c. At least one coil 26, having a central axis 26a, is remote from said at least one rotor 22 to be away from a direct influence of the alternating magnetic field. Further, a magnetic or ferromagnetic bridge is described. The magnetic or ferromagnetic bridge includes at least a first and second bridge 20 elements 24a, 24b joining and electrically coupling said rotor 22 to said coil 26. The first and second bridge elements 24a, 24b include protrusions or teeth 24c at a vicinity of and located in a circle around said magnetic elements 22b so that a voltage within the coil 26 is induced due to the alternating magnetic field within the magnetic or ferromagnetic bridge 24a, 24b caused by the rotation of the magnetic elements 22b.

25 The protrusions or teeth 24c are interdigitated between both halves of the magnetic or ferromagnetic bridge 24a, 24b and a total number of the protrusions or teeth 24c corresponds to double a number of pole pairs defined by the one or more magnetic elements 22b.

Said first bridge element 24a forms a first plane orthogonal to said axis of rotation 22c. Said second bridge element 24b forms a second plane orthogonal to said axis of rotation 22c. The teeth 24c of the first bridge element 24a and the teeth 24c of the second bridge element 24b are arranged at an angle orthogonal to the corresponding first and second planes around the rotor 22. Said magnetic elements 22b are arranged radially to the rotor 22 to face the teeth 24c of each of the first bridge element 24a and the second bridge element 24b. Further, a thickness (see thicknesses T1, T2) of one or both of the first and second bridge elements 24a, 24b decreases from the rotor 22 to the coil 26 (see FIG. 18).

The rotor 22 forms a rotation plane 22d orthogonal to the axis of rotation 22c and includes a rotor shaft 36a. One end of the rotor shaft 36a includes a coupling element 36b adapted to transmit an external mechanical force to the rotor 22 to rotate the rotor 22 around the axis of rotation 22c.

The central axis 26a of the coil 26 is non-parallel to the axis of rotation 22c of the rotor 22 so that said central axis 26a is twisted with respect to the axis of rotation 22c.

In some embodiments, the electric generator device 20 includes at least two coils 26. Each coil 26 contains one central axis 26a. An overall centroidal axis 26b passes through the overall geometrical center, or barycenter, of all of the central axes 26a. The overall centroidal axis 26b is arranged non-concentrically and/or non-parallel with respect to the axis of rotation 22c of the rotor 22.

The magnetic or ferromagnetic bridge 24a, 24b includes material selected from one of a group of materials consisting of Fe, Co, Cr or Ni and a metalloid, preferably C, B, Si, V, M or an alloy of at least two of these materials.

The first bridge element 24a includes a first bearing 32a and the second bridge element 24b includes a second bearing 32b, the first and the second bridge elements 24a, 24b are attached to each other by the screw 34 engaging with a mating thread 34′. The first bridge element 24a and the second bridge element 24b each include interlocking elements for preventing rotational displacement of the first bridge element 24a to the second bridge element 24b when attached to each other by the screw 34 engaging with the mating thread 34′.

The magnetic or ferromagnetic bridge 24a, 24b includes at least one extension 24d for attaching the electric generator device 20 to any mechanical structure.

In some embodiments, the electric generator device 20 includes at least two coils 26. The at least two coils, or some of them, are connected in parallel, or said at least two coils, or some of them, are connected in series.

The number of teeth is equally distributed between both bridge halves and one tooth per half bridge is attributed to one pole of each of the pole pairs.

All teeth per bridge halve are exposed to a same magnetic field direction. A magnetic field direction associated with one bridge halve is opposite to the magnetic field direction associated with the other bridge halve.

The magnetic elements 22b are affixed to the rotor 22 and are spaced apart from the teeth to define a radial distance or an air gap with the teeth. The radial distance is constant around the axis of rotation and is at least twice as small as an axial distance between the magnetic elements 22b and the magnetic or ferromagnetic bridge. Further, the air gap 48 is defined anywhere within a range of 0.1 to 0.3 millimetres (mm) or within a range of 0.1 and 0.2 mm.

Each of the teeth, along the radial distance, has a width ranging anywhere between 0.1 to 0.4mm or between 0.2 to 0.3 mm.

The magnetic element includes at least one permanent magnet in a ring shape. The permanent magnet is radially magnetized into at least one pole pair. The permanent magnet including at least one of a bonded permanent magnet or a sintered permanent magnet. The pole pairs associated with the magnetic element correspond to anywhere between 4 to 10 pole pairs or to 7 pole pairs.

A wearable device, such as a watch, a wristwatch, a jewel, a fashion item, includes the electric generator device 20.

It should be appreciated that the particular implementations shown and herein described are representative of the invention and its best mode and are not intended to limit the scope of the present invention in any way.

Moreover, the device contemplates the use, sale and/or distribution of any goods, services or information having similar functionality described herein.

The specification and figures should be considered in an illustrative manner, rather than a restrictive one and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

In accordance with the provisions of the patent statutes, the present invention has been described in what is considered to represent its preferred embodiment. However, it should be noted that the invention can be practiced otherwise than as specifically illustrated and described without departing from its spirit or scope.

### REFERENCE NUMBERS USED IN THE FIGS.

20 Generator
22 Rotor
22a Rotor yoke
22b Magnetic elements
22c Rotor axis
22d Rotation plane
24a First bridge element
24b Second bridge element
24a′ Intermediate bridge
24c Protrusions
24d Through hole
26 Coil
26a Central axis
26b Overall centroid axis
32a, 32b Ball bearing
34 Fixing element
36a Rotor shaft
36b Coupling element
40 Electrical connection means
48 Air gap
58 Axial distance

What is claimed is:

1. An electric generator device (20) comprising:
at least one rotor (22) having an axis of rotation (22c) and comprising one or more magnetic elements (22b) disposed around the axis of rotation (22c) on the rotor yoke (22a), the one or more magnetic elements (22b) defining pole pairs adapted to create an alternating magnetic field when rotated around the axis of rotation (22c);
at least one coil (26), having a central axis (26a), said at least one coil (26) being remote from said at least one rotor (22) such that the coil is located non-coaxial with, offset from or away from a direct influence of the alternating magnetic field such that central axis (26a) is outside an envelope of the rotor, and
a magnetic or ferromagnetic bridge, comprising at least a first and second bridge elements (24a, 24b) joining said at least one rotor (22) to said at least one coil (26), said at least first and second bridge elements (24a, 24b) comprising couplers in form of protrusions or teeth (24c) in the vicinity of and located to encircle said one or more magnetic elements (22b) so that a voltage within the at least one coil (26) is induced due to the alternating magnetic field within said magnetic or ferromagnetic bridge (24a, 24b) caused by the rotation of the one or more magnetic elements (22b) around the axis of rotation (22c), wherein
the protrusions or teeth (24c) are interdigitated between both halves of the magnetic or ferromagnetic bridge (24a, 24b) and a total number of the protrusions or teeth (24c) corresponds to double the number of pole pairs defined by the one or more magnetic elements (22b).

2. The electric generator device (20) of claim 1, wherein
said first bridge element (24a) forms a first plane orthogonal to said axis of rotation (22c), said second bridge element (24b) forms a second plane orthogonal to said axis of rotation (22c), and wherein the teeth of the first bridge element (24a) and the teeth of the second bridge element (24b) are arranged at an angle orthogonal to the corresponding first and second planes around the at least one rotor (22), said one or more magnetic elements (22b) being arranged radially to the at least one rotor (22) to face the teeth of each of the first bridge element and the second bridge element, and
a thickness of one or both of the first and second bridge elements (24a, 24b) decreases from the at least one rotor (22) to the at least one coil (26).

3. The electric generator device (20) of claim 1, wherein the at least one rotor (22) forms a rotation plane (22d) orthogonal to the axis of rotation (22c) and comprises a rotor shaft (36a), one end of said rotor shaft (36a) comprising a coupling element (36b) adapted to transmit an external mechanical force to the at least one rotor (22) to rotate the at least one rotor (22) around the axis of rotation (22c).

4. The electric generator device (20) of claim 1, wherein the central axis (26a) of the at least one coil (26) is non-parallel or non-coaxial to the axis of rotation (22c) of the at least one rotor (22) so that said central axis is twisted with respect to the axis of rotation (22c).

5. The electric generator device (20) of claim 1 comprising at least two coils (26), whereby each coil (26) contains one central axis (26a), whereby an overall centroidal axis (26b) passes through the overall geometrical center, or barycenter, of all of the central axes (26a), whereby the overall centroidal axis (26b) is arranged non-concentrically and/or non-parallel with respect to the axis of rotation (22c) of the at least one rotor (22).

6. The electric generator device (20) of claim 1, wherein the magnetic or ferromagnetic bridge (24a, 24b) includes material selected from one of a group of materials consisting of Fe, Co, Cr or Ni and a metalloid, preferably C, B, Si, V, M or an alloy of at least two of these materials.

7. The electric generator device (20) of claims 1, whereby the first bridge element (24a) comprises a first bearing (32a) and the second bridge element (24b) comprises a second bearing (32b), the first and the second bridge elements (24a, 24b) are attached to each other by one or more screws (34) engaging with a mating thread (34′), whereby the first bridge element (24a) and the second bridge element (24b) each comprise interlocking elements for preventing rotational displacement of the first bridge element (24a) to the second bridge element (24b) when attached to each other by the one or more screws (34) engaging with the mating thread (34′).

8. The electric generator device (20) of claim 1, whereby the magnetic or ferromagnetic bridge (24a, 24b) comprises at least one extension (24d) for attaching the electric generator device (20) to any mechanical structure.

9. The electric generator device (20) of claim 1, comprising at least two coils (26), wherein said at least two coils, or some of them, are connected in parallel, or wherein said at least two coils, or some of them, are connected in series.

10. The electric generator device (20) according to claim 1, comprising a plurality of coils and at least one phase.

11. The electric generator device (20) according to claim 1, comprising at least one coil (26) and a rotor (22) rotating relative to the coil or a rotor (22) and at least one coil (26) rotating relative to one another or at least one coil (26) and rotor (22), both rotating.

12. The electric generator device (20) according to claim 1, wherein, when rotating relative to the at least one coil, the rotor generates an alternating magnetic field within the surroundings of the rotor, thus creating an alternating magnetic field passing through the ferromagnetic bridges, thereby inducing electrical voltage within the at least one coil.

13. The electric generator device (20) according to claim 1, wherein, when an electrical load is connected to the at least one coil, a current circulates within the electrical load as a consequence of the voltage produced by the at least one coil, thereby transmitting electrical power to the electrical load.

14. The electric generator device (20) according to claim 13, wherein the electrical load is defined by, or comprises a resistance, an inductance, a capacitor, a filter, a diode rectifier bridge, a LED, a battery, or a combination thereof, or any other device having an electrical characteristic.

15. The electric generator device (20) according to claim 13, wherein the electrical load further comprises devices or accessories having one or several movable parts, which may be optionally combined with lights, as long as such device or accessories can be activated by an electrical source.

16. The electric generator device (20) according to claim 1, wherein because the at least one coil is in the vicinity of the rotor, the at least one coil is affected by the alternating magnetic field located in the ferromagnetic bridge.

17. The electric generator device (20) according to claim 1, wherein, the ferromagnetic bridge locally transmits the alternating magnetic field generated by the rotor to the at least one coil for inducing voltage within the at least one coil.

18. The electric generator device (20) according to claim 1, wherein couplers in form of protrusions or teeth which extend radially couple the radial magnetic field of the rotor into the magnetic or ferromagnetic bridge allowing a certain free space around the concentrically located rotor, and are an integral part of the ferromagnetic bridges.

19. The electric generator device (20) according to claim 18, wherein the couplers form a cylindrical cage-like structure.

20. The electric generator device (20) according to claim 18, wherein the ferromagnetic bridge is shaped to concentrate the magnetic flux from the couplers towards and through the coil.

21. The electric generator device (20) according to claim 1, wherein the ferromagnetic bridge extends via a cylindrical extension of the ferromagnetic bridge through the center of the coil and this extension has an outer diameter of 1 to 2 mm, preferably 1.4 to 1.5 mm.
